(19) United States
(12) Patent Application Publication
(10) Pub. No.: US 2012/0281028 A1
(43) Pub. Date: Nov. 8, 2012

(54) Method and System for Backlight Control Using Statistical Attributes of Image Data Blocks

(75) Inventors: Christopher J. Orlick, Washington Crossing, PA (US); Jerome D. Shields, Lumberton, NJ (US); J. Scott Miller, Harleysville, PA (US)

(73) Assignee: DOLBY LABORATORIES LICENSING CORPORATION, SAN FRANCISCO, CA (US)

(21) Appl. No.: 13/511,534

(22) PCT Filed: Dec. 9, 2010
(86) PCT No.: PCT/US10/59642

§ 371 Date: May 23, 2012

Related U.S. Application Data
(60) Provisional application No. 61/286,884, filed on Dec. 16, 2009.

(51) Int. Cl. G09G 3/36; G09G 5/10

(52) U.S. Cl. 345/690; 345/102

(57) ABSTRACT

A method and system for generating backlight control values for a dual modulation display including a front panel having a first resolution and a backlight subsystem having lower resolution than the front panel, in response to input image data. Some embodiments determine statistical data indicative of at least one statistical measure of each of a number of spatially compact subsets of pixels of image data having the first resolution, where the pixels of image data are pixels of the input image data, color components of pixels of the input image data, or data values derived from pixels of the input image data. Some embodiments determine backlight drive values for each color channel of the backlight subsystem, including by determining statistical data for each color channel, determining backlight drive values for each color channel from the statistical data, and performing cross-channel correction on these backlight drive values.

### CROSS-REFERENCE TO RELATED APPLICATIONS

This application claims priority to U.S. Patent Provisional Application No. 61/286,884, filed 16 Dec. 2009, hereby incorporated by reference in its entirety.

### BACKGROUND OF THE INVENTION

1. Field of the Invention

The invention relates to systems and methods for controlling backlight panels of dual modulation displays in response to input image data. Some embodiments of the inventive system and method determine at least two statistical attributes (e.g., mean and standard deviation) of each of a number of subsets (blocks) of pixels of an image and use them to determine individual settings for backlights (e.g., LED cells) of a dual modulation display, preferably to achieve an improved (e.g., maximized) displayed image contrast ratio while achieving stable backlight and reducing (e.g., minimizing) clipping, contouring, and motion artifacts, and preferably also optimizing energy efficiency.

2. Background of the Invention

Throughout this disclosure including in the claims, the expression performing an operation “on” signals or data (e.g., filtering, scaling, or transforming the signals or data) is used in a broad sense to denote performing the operation directly on the signals or data, or on processed versions of the signals or data (e.g., on versions of the signals that have undergone preliminary filtering prior to performance of the operation thereon).

Throughout this disclosure including in the claims, the expression “system” is used in a broad sense to denote a device, system, or subsystem. For example, a subsystem that implements a filter may be referred to as a filter system, and a system including such a subsystem (e.g., a system that generates X output signals in response to multiple inputs, in which the subsystem generates M of the inputs and the other X−M inputs are received from an external source) may also be referred to as a filter system.

One type of conventional display, known as a dual modulation display, includes a modulating front panel (typically an LCD panel comprising an array of LCD elements) and a spatially variable backlight system (typically a backlight panel comprising an array of individually controllable LEDs). Dual modulation displays can provide greater contrast ratios than can traditional displays. The backlight drive values (e.g., LED drive values) should be chosen to achieve an optimal backlight, including by maximizing contrast, while minimizing visual artifacts (e.g., white clipping, black clipping, and halos) and temporal variations of these artifacts and maximizing energy efficiency. The ideal solution balances these criteria for a given application. Preferably, the backlight drive values control the backlight system to mitigate display artifacts such as bright pixel clipping, dark clipping and contouring, and output variation with motion and image deformation.

Contrast ratio is defined as the ratio of the brightest to darkest colors that a display is capable of producing. High contrast ratios are desirable for accurate image reproduction, but are often limited in traditional displays. One traditional display consists of a Liquid Crystal Display (LCD) panel and a backlight, typically a cold cathode fluorescent lamp (CCFL) disposed behind the LCD panel. The display contrast ratio is set by the LCD contrast ratio, which is typically under 1000:1. Dual modulation displays are typically formed from the combination of a Liquid Crystal Display (LCD) panel, and an array of individually controlled Light Emitting Diodes (LEDs) disposed behind the LCD panel.

In a dual modulation display, the contrast at the LCD panel is increased by multiplication by the contrast of the LED backlight. Usually, the backlight layer emits light corresponding to a low-resolution version of an image, and the LCD panel (which has a higher resolution) transmits light (by selectively blocking light from the backlight layer) to display a high-resolution version of the image. In effect, the high and low resolution “images” are multiplied optically.

In a dual modulation display, nearby LCD pixels have similar backlighting. If an input image contains pixel values beyond the contrast range of an LCD panel, the backlight will not be optimal for all LCD pixels. Typically the choice of backlighting level for a local area of an LCD panel is not optimal for all LCD pixels in the area. For some LCD pixels the backlight might be too high, while for others the backlight might be too low. The backlighting should be set to best represent the input signal from a perceptual standpoint, i.e., the backlight level should be chosen to allow the best perceptual representation of the bright and dark pixels, which often cannot both be accurately represented.

If backlighting is too high, accurate low levels including black are compromised. Input image pixel values requiring LCD values near the minimum LCD transmittance are contoured (quantized), and pixels requiring LCD values below the minimum LCD transmittance are clipped to the lowest level. If the backlighting is too low, pixels above the backlight level are clipped to the maximum LCD level. These clipping and contouring artifacts may occur in traditional constant backlit LCD displays. Perceptually (to many viewers), white clipping artifacts are more objectionable than black contouring and clipping.

Another artifact that may occur when backlighting is too high is termed a “halo.” A halo can be seen when the backlight is very high in the area of a dark background. This can occur due to a very bright object near the dark area. The halo artifact is the backlight shape becoming visible, or showing through, an area of the LCD panel that is at low (e.g., minimum) transmittance. In the area of a halo, the LCD panel cannot completely compensate for the high backlight level, and the backlight shape is viewed through the LCD pixels.

Motion video (display of a changing sequence of images) adds additional problems. Artifacts within a still image may be less noticeable than those which change over time and with motion. In typical scenes, both white and black clipped pixels are often present and the clipped pixels are visible. If the shape and/or intensity of the backlight signal changes as the image features move, the artifacts will also change. For clipping and contouring artifacts, this results in changes in both the actual pixels that clip and contour, and the brightness of affected pixels. If halos are present, a changing backlight results in changing halos. In all cases, the effect of the changing backlight intensifies the clipping, contouring, and halo artifacts.

To prevent motion artifacts from occurring, the shape and position of a displayed image and the corresponding backlight should remain stable. This means that the backlight should not change in response to simple object motion (e.g., translation of a displayed object) to prevent the backlight pattern from moving (e.g., translating) along with the object. In other words, the backlight should be invariant to object location. It also means that as the displayed image deforms and changes, the backlighting should change in a smooth, deterministic manner corresponding to the changes in the input image.

For efficiency, it also is desired that the backlight panel of a dual modulation display not generate too much light because excess light must be blocked by the LCD layer in order to display an accurate image. Thus, for efficiency the backlight control signal values should, in the absence of other considerations, be generated to have 100% of the light level transmitted through the LCD layer. Backlight levels above 100% are inefficient because they may be blocked by the LCD layer.

Many criteria determine backlight performance and many methods for generating backlight control values for dual modulation displays have been proposed. Desirably backlight control values should be generated in a manner that optimally balances the criteria and allows adjustment based on LCD and LED performance.

Conventionally, individual backlight (e.g., LED) drive values for a dual modulation display are generated from input image data indicative of each image to be displayed. An example of a conventional method for determining individual backlight settings for a dual modulation display is described in U.S. Pat. No. 7,505,027 to S. J. Daly, issued Mar. 17, 2009. This method assumes that the display's backlighting array has lower resolution than the front (LCD) panel. To display an image in accordance with the method, the front panel is driven directly by input image data (indicative of the image to be displayed) and luminance data (indicative of the luminance of each pixel of the image to be displayed) are generated from the input image data. The luminance data are low-pass filtered and the low-pass filtered luminance data are used to determine backlight array drive values. Specifically, the method computes the mean luminance of each image area (“neighborhood” of pixels) of the input image, and determines the maximum luminance of each neighborhood. Thus, the method determines the mean and maximum luminance of each neighborhood of pixels (of the front panel) to be illuminated by each different light source of the backlighting array. In an effort to improve the dynamic range of the displayed image, if the maximum luminance exceeds a predetermined threshold value, the corresponding light source of the backlighting array is driven to a full illumination level; and if the maximum luminance does not exceed the threshold, the light source is attenuated (driven to a reduced level determined using a look-up table from the mean luminance of the neighborhood). The reference also suggests without explanation that since the light distribution from a point source of the backlighting array is not uniform over an image area (neighborhood) of the front panel illuminated by the point source, statistical measures “other than mean luminance” may be used to determine appropriate attenuation of the point source (in the case that maximum luminance of the relevant neighborhood does not exceed the threshold value).

The method described in U.S. Pat. No. 7,505,027 for determining individual backlight settings is impractical and limited for a number of reasons including the following. The method would not achieve good display quality or adequately reduce artifacts when displaying a sequence of input images indicative of at least one moving bright object (e.g., a cursor or other bright object translating across the display screen). In this case, the method would typically produce a translating halo artifact having the appearance of a displayed halo (excessively backlit area) surrounding each bright moving object as the object moves across the display screen. The halo would likely move non-uniformly with the moving object, and the size, shape, and brightness of the halo would likely change as the non-deforming object translates across the screen. In contrast, preferred embodiments of the method described herein determine the mean and standard deviation of each of a number of subsets (blocks) of pixels of an image and use them to determine backlight drive values that achieve stable backlight and prevent translation artifacts (e.g., translating halo artifacts) that would result from conventional methods.

Also undesirably, the low pass filtering performed by the method of U.S. Pat. No. 7,505,027 is performed on the full set of luminance values of the input image rather than on a reduced set of image data values (e.g., luminance values of a downsampled version of each input image).

Thus, the low-pass filtering operation of U.S. Pat. No. 7,505,027 is complicated and expensive to implement. In contrast, preferred embodiments of the method described herein apply bandlimiting filters (e.g., low pass filters) to reduced resolution downsampled images determined from full resolution input image data, rather than to the full resolution input image data.

In general, conventional methods for determining individual backlight settings for a dual modulation display undesirable cause image artifacts and are complicated and expensive to implement. There is a need for efficiently implementable methods and apparatus for determining individual backlight (e.g., LED) settings for a dual modulation display in order to achieve stable backlight and an improved (e.g., maximized) displayed image contrast ratio while minimizing clipping, contouring, and motion artifacts, and optimizing energy efficiency.

### BRIEF DESCRIPTION OF THE INVENTION

In a class of embodiments, the invention is a method and system for generating backlight control values for a dual modulation display including a front panel (e.g., an LCD panel) and a backlight subsystem (sometimes referred to herein as a backlight panel) having lower resolution than the front panel. Typically, the display is configured so that each backlight element (e.g., LED cell) of the backlight panel backlights many pixels of the front panel.

In a class of embodiments of the inventive method and system, backlight drive values (sometimes referred to herein as backlight control values) for individual backlight elements are generated from “low resolution” statistical data indicative of at least two statistical measures (e.g., standard deviation and mean) of spatially compact subsets (blocks) of pixels of “high resolution” image data, where the “high resolution” image data are input image data (having higher resolution than the statistical data) indicative of an image to be displayed, or data (having higher resolution than the statistical data) derived from such input image data. For example, the high resolution image data may be luminance data (e.g., a luminance value for each pixel of an input image), maximal color component data (e.g., a maximal color component of the color components of each pixel of an input image), input image data itself (color components of each pixel of an input image), or other high resolution image data. Typically, individual backlight drive values are generated from low resolution statistical data indicative of a linear combination of the standard deviation and mean of each of a number of compact subsets of pixels of each image of an image sequence (e.g., video program) to be displayed. For each image, the spatial locations of the compact subsets of pixels correspond to spatial locations of pixels of a lower resolution version of the image (sometimes referred to herein as a “downsampled” image or a “downsampled” version of an input image).

The resolution of each downsampled image is closely related (e.g., identical, in some cases) to the resolution of the backlight panel. For example, if the backlight elements are arranged as a rectangular grid (e.g., a rectangular array of LED cells), the downsampled image resolution can be equal to the backlight grid resolution or a multiple of the backlight grid resolution (i.e., N times the backlight grid resolution, where N is an integer). If the backlight grid is arranged other than as a rectangular grid (e.g., as a hexagonal array of backlight elements), the spatial locations of the pixels of the downsampled image can correspond to the minimal (lowest resolution) rectangular grid that contains all the backlight element positions. Such a minimal rectangular grid allows for easier and more efficient implementation of the inventive system and method.

Preferred embodiments of the invention determine at least two statistical attributes (e.g., mean and standard deviation) of blocks of image data (input image data or image data derived from input image data) in an efficient manner, and use them to determine backlight drive values. In preferred embodiments, the statistical measures are determined from input image data at a relatively low resolution equal to the resolution of a downsampled version of each input image. Preferably, at least one statistical attribute is determined for each pixel subset of a number of pixel subsets (blocks) of a full resolution image (an input image or full resolution image derived from an input image) by a method including at least one nonlinear operation on data indicative of (e.g., derived from) the pixel subset. Herein, including in the claims, the expression “nonlinear operation” on data values is intended to exclude the operation of determining a subset (e.g., one) of the values that satisfies a predetermined criterion (e.g., it is not intended to denote an operation of determining a maximum or minimum one of the values, or an operation of determining which of the values exceed a predetermined threshold value). An example of the nonlinear operation performed in some preferred embodiments of the inventive method is an operation of squaring image data values, and the method (in these embodiments) may generate a standard deviation value for each of a number of pixel subsets of a full resolution image. For each of the statistical attributes determined in preferred embodiments of the invention, a low resolution “image” (a downsampled image) consisting of values of the statistical attribute (or values derived from such values) is determined from each full resolution image. The backlight drive values are determined from the low resolution images in order to achieve stable backlight and to reduce or prevent artifacts (e.g., translating halo artifacts) that would result during full resolution image display using conventional backlight control (e.g., conventional backlight control that does not include an nonlinear operation of the described type). Backlight drive values determined in accordance with preferred embodiments cause the display to produce stable backlight and also reduce or eliminate such artifacts. In some preferred embodiments, backlight drive values are determined from a downsampled image consisting of values each equal to a linear combination of the standard deviation and mean of a different compact subset of pixels of an image to be displayed, where this downsampled image is determined from two other downsampled images: one consisting of the standard deviation of each of the compact subsets of pixels; the other consisting of the mean of each of the compact subsets of pixels.

In a first class of embodiments of the inventive method and system, a backlight control value is determined for each backlight element (e.g., each LED cell) of the backlight panel of a dual modulation display in response to input image data. Typically, the input image data determine a sequence of color images, and comprise red, green, and blue color components (or other color components, in the case of images having non-RGB colorspaces). In typical embodiments in the first class, color components of each input image are transformed to determine a luminance image (e.g., a luminance value is determined for each pixel of the input image, by a traditional colorimetric technique such as a per-pixel weighted summation of the input image color components). Other typical embodiments in the first class determine the maximal value of the color components of each pixel of the input image (or each pixel of a subset of the pixels of the input image). The backlight control values are determined from the resulting luminance values or maximal color component values. The backlight control values (e.g., LED drive values) can be directly applied to white backlight cells of the backlight panel. For example, they can be applied directly to a white LED comprising each such cell, or directly to each LED of a cluster of red, green and blue LEDs comprising each such cell.

Preferred embodiments in the first class determine at least two statistical attributes (e.g., mean and standard deviation) of each block in a set of blocks of input image pixels (raw input image pixels, or pixels (e.g., luminance values) derived from raw input image pixels), and use the attributes to determine the backlight control values. Preferably, at least one statistical attribute is determined for each block of input image pixels by a method including at least one nonlinear operation on data of the block.

In a second class of embodiments of the inventive method and system, a set of backlight control values is determined for each color channel of each backlight element (cell) of a backlight panel of a dual modulation display (e.g., for each of red, green, and blue channels of each backlight element of a backlight array). In typical embodiments in this class, a set of backlight control values is generated independently for each color channel of the backlight panel, and a cross-channel correction operation is performed on these sets of backlight control values to determine a modified set of backlight control values for each color channel. Embodiments in the second class can improve both the achievable color gamut and overall system efficiency (relative to the color gamut and system efficiency achievable by the above-described first class of embodiments).

In preferred embodiments in the second class, at least two statistical attributes (e.g., mean and standard deviation) of each block in a set of blocks of input image color components are determined for each color channel of an input image, and the backlight control values are determined from the statistical attributes. Preferably, at least one statistical attribute is determined for each block of input image color components by a method including at least one nonlinear operation on data of the block.

In preferred embodiments in both the first class and the second class, a bandlimiting filter (e.g., a low pass filter) is applied to a downsampled image (or to each of a number of downsampled images) generated during generation of backlight control values to remove high frequencies in the downsampled image. Failure to so filter a downsampled image could result in aliasing (due to the downsampling step) that could cause visual artifacts in the displayed image. An important advantage of applying the bandlimiting filter(s) to relatively low resolution data (the downsampled image) rather than to higher resolution data (e.g., full resolution input image data) is that this allows the filter(s) to be simple and inexpensive to implement.

In a third class of embodiments, the invention is a method for determining backlight drive values for backlight elements of a backlight panel of a dual modulation display in response to input image data indicative of an image to be displayed, said method including the steps of:

(a) determining statistical data indicative of at least one statistical measure of each of a number of spatially compact subsets of pixels of image data, including by performing at least one nonlinear operation on each of the spatially compact subsets, where the dual modulation display includes a front panel having a first resolution, the image data being mapped to the first resolution, the statistical data have resolution lower than said first resolution, and the pixels of image data are elements of the group consisting of pixels of the input image data, color components of pixels of the input image data, and data values derived from pixels of the input image data; and

(b) determining the backlight drive values from the statistical data.

In some embodiments in the third class, the pixels of image data are luminance values, including a luminance value for each pixel of the input image data. In some other embodiments in the third class, the pixels of image data are maximal color components, including a maximal color component of the color components of each pixel of the input image data.

In some embodiments in the third class, the statistical measure is the standard deviation of each of the spatially compact subsets of pixels of image data. In some such embodiments, step (a) includes a step of determining the mean of each of the spatially compact subsets of pixels and step (b) includes a step of determining each of the backlight drive values from a linear combination of the standard deviation and the mean of a different one of the spatially compact subsets of pixels.

The nonlinear operation may be performed on each of the spatially compact subsets or on data derived from each of the spatially compact subsets. In some embodiments in the third class, the nonlinear operation is an operation of squaring pixels of each of the spatially compact subsets (and in some such embodiments, the statistical measure is the standard deviation of each of the spatially compact subsets). In other embodiments, the nonlinear operation is an operation of squaring pixels of a downsampled image determined from the spatially compact subsets (e.g., an operation of squaring the mean value of each of the spatially compact subsets, where each pixel of the downsampled image is the mean value of a different one of the spatially compact subsets, or an operation of squaring low-pass filtered mean values of the spatially compact subsets). In some embodiments, the statistical data are indicative of the mean and standard deviation of each of the spatially compact subsets, and step (a) includes a step of determining standard deviation values including by filtering mean values of the spatially compact subsets to determine filtered mean values, and squaring each of the filtered mean values.

In some embodiments in the third class, steps (a) and (b) are performed by single pass data processing (without feedback). In response to the backlight drive values produced in typical embodiments in the third class, the backlight panel produces stable backlight.

In a fourth class of embodiments, the invention is a method for determining backlight drive values for backlight elements of a backlight panel of a dual modulation display in response to input image data indicative of an image to be displayed, said method including the steps of:

(a) determining statistical data indicative of at least two statistical measures of each of a number of spatially compact subsets of pixels of image data, where the dual modulation display includes a front panel having a first resolution, the image data being mapped to the first resolution, the statistical data have resolution lower than said first resolution, and the pixels of image data are elements of the group consisting of pixels of the input image data, color components of pixels of the input image data, and data values derived from pixels of the input image data; and

(b) determining the backlight drive values from the statistical data.

In some embodiments in the fourth class, the pixels of image data are luminance values, including a luminance value for each pixel of the input image data. In some other embodiments, the pixels of image data are maximal color components, including a maximal color component of the color components of each pixel of the input image data.

In some embodiments in the fourth class, the statistical measures include the standard deviation and the mean of each of the spatially compact subsets of pixels of image data. In some such embodiments, step (b) includes the step of determining each of the backlight drive values from a linear combination of the standard deviation and the mean of a different one of the spatially compact subsets of pixels of image data.

In some embodiments in the fourth class, the statistical data are determined by steps including at least one nonlinear operation on each of the spatially compact subsets. The nonlinear operation may be performed on each of the spatially compact subsets or on data derived from each of the spatially compact subsets. For example, the nonlinear operation can be or include an operation of squaring pixels of each of the spatially compact subsets. For another example, the nonlinear operation can be or include an operation of squaring pixels of a downsampled image determined from the spatially compact subsets (e.g., an operation of squaring the mean value of each of the spatially compact subsets, or a filtered mean value of each of the spatially compact subsets, where each pixel of the downsampled image is the mean value of a different one of the spatially compact subsets).

In some embodiments in the fourth class, steps (a) and (b) are performed by single pass data processing (without feedback). In response to the backlight drive values produced in typical embodiments in the fourth class, the backlight panel produces a stable backlight.

In a fifth class of embodiments, the invention is a method for determining backlight drive values for backlight elements of each color channel of a backlight panel of a dual modulation display in response to input image data indicative of an image to be displayed, where the backlight panel has a first color channel for emitting light of a first color, a second color channel for emitting light of a second color, and a third color channel for emitting light of a third color, and the dual modulation display also includes a front panel having a first resolution, said method including the steps of:

(a) determining first statistical data indicative of at least one statistical measure of each of a number of spatially compact subsets of first image pixels, where the first statistical data have resolution lower than said first resolution, and the first image pixels are elements of the group consisting of color components having the first color of the input image data, and data values derived from color components having the first color of the input image data, and determining backlight drive values for the first color channel from the first statistical data;

(b) determining second statistical data indicative of at least one statistical measure of each of a number of spatially compact subsets of second image pixels, where the second statistical data have resolution lower than said first resolution, and the second image pixels are elements of the group consisting of color components having the second color of the input image data, and data values derived from color components having the second color of the input image data, and determining backlight drive values for the second color channel from the second statistical data;

(c) determining third statistical data indicative of at least one statistical measure of each of a number of spatially compact subsets of third image pixels, where the third statistical data have resolution lower than said first resolution, and the third image pixels are elements of the group consisting of color components having the third color of the input image data, and data values derived from color components having the third color of the input image data, and determining backlight drive values for the third color channel from the third statistical data; and

(d) performing cross-channel correction on the backlight drive values for the first color channel, the backlight drive values for the second color channel, and the backlight drive values for the third color channel to generate modified backlight drive values for the first color channel, modified backlight drive values for the second color channel, and modified backlight drive values for the third color channel.

In some embodiments in the fifth class, the first statistical data are determined by steps including at least one nonlinear operation on each of the spatially compact subsets of first image pixels (e.g., on each of the spatially compact subsets or on data derived from each of the spatially compact subsets), the second statistical data are determined by steps including at least one nonlinear operation on each of the spatially compact subsets of second image pixels, and the third statistical data are determined by steps including at least one nonlinear operation on each of the spatially compact subsets of third image pixels. In some embodiments, each nonlinear operation is an operation of squaring pixels of each of the spatially compact subsets (and in some such embodiments, the statistical measure is the standard deviation of each of the spatially compact subsets). In other embodiments, the nonlinear operation is an operation of squaring pixels of a downsampled image determined from the spatially compact subsets (e.g., an operation of squaring the mean value of each of the spatially compact subsets, or a filtered mean value of each of the spatially compact subsets, where each pixel of the downsampled image is the mean value of a different one of the spatially compact subsets). In some embodiments, the first statistical data are indicative of the mean and standard deviation of each of the spatially compact subsets of first image pixels, the second statistical data are indicative of the mean and standard deviation of each of the spatially compact subsets of second image pixels and the third statistical data are indicative of the mean and standard deviation of each of the spatially compact subsets of third image pixels.

In some embodiments in the fifth class, steps (a), (b), (c), and (d) are performed by single pass data processing (without feedback). In response to the modified backlight drive values produced in typical embodiments in the fifth class, the backlight panel produces stable backlight.

Aspects of the invention include a system configured (e.g., programmed) to perform any embodiment of the inventive method, and a computer readable medium (e.g., a disc) which stores code for implementing any embodiment of the inventive method. For example, the inventive system can be or include a field-programmable gate array (or other integrated circuit or chip set) programmed and/or otherwise configured to perform an embodiment of the inventive method in response to video or other input image data asserted thereto, or another programmable digital signal processor that is programmed and/or otherwise configured to perform pipelined processing, including an embodiment of the inventive method, on video or other image data. Alternatively, the inventive system is or includes a programmable general purpose processor or microprocessor, coupled to receive or to generate input data indicative of a sequence of images to be displayed, and programmed with software or firmware and/or otherwise configured to perform any of a variety of operations on the input data, including an embodiment of the inventive method. For example, the inventive system may be or include a computer system including an input device, a memory, and a graphics card that is programmed (and/or otherwise configured) to perform an embodiment of the inventive method in response to input image data asserted thereto.

### BRIEF DESCRIPTION OF THE DRAWINGS

FIG. 1 is a block diagram of an embodiment of the inventive system.

FIG. 2 is a diagram of pixels 5 of an LCD array of a dual modulation display, and LED cells 6 of the display's backlight panel.

FIG. 3 is a diagram of the high resolution LCD array of FIG. 2 aligned with (superimposed on) the lower resolution backlight panel of FIG. 2.

FIG. 4 is a diagram of the aligned LCD array and backlight panel of FIG. 2, with a downsampled image comprising pixels 7 that can be employed in accordance with an embodiment of the invention to generate backlight drive values for LED cells 6 of FIG. 2.

FIG. 5 is a diagram of LCD array pixels 5 and downsampled image pixels 7 of FIG. 4.

FIG. 6 is a diagram of pixels 5 of an LCD array of another dual modulation display, and LED cells 6′ of the display's backlight panel.

FIG. 7 is a diagram of the high resolution LCD array of FIG. 6 aligned with (superimposed on) the lower resolution backlight panel of FIG. 6.

FIG. 8 is a diagram of the aligned LCD array and backlight panel of FIG. 7, with a downsampled image comprising pixels 7′ that can be employed in accordance with an embodiment of the invention to generate backlight drive values for LED cells 6′ of FIG. 6.

FIG. 9 is a flow diagram of steps performed in typical operation of the FIG. 1 system or other embodiments of the inventive system.

FIG. 10 is a flow diagram of steps performed in a typical implementation of step 70 of FIG. 9 to generate LED drive values in response to input image data.

FIG. 11 is a block diagram of another embodiment of the inventive system that is configured to generate LED drive values in response to input image data.

FIG. 12 is a flow diagram of steps performed in typical operation of block 203 of the FIG. 11 system.

### DETAILED DESCRIPTION OF THE PREFERRED EMBODIMENTS

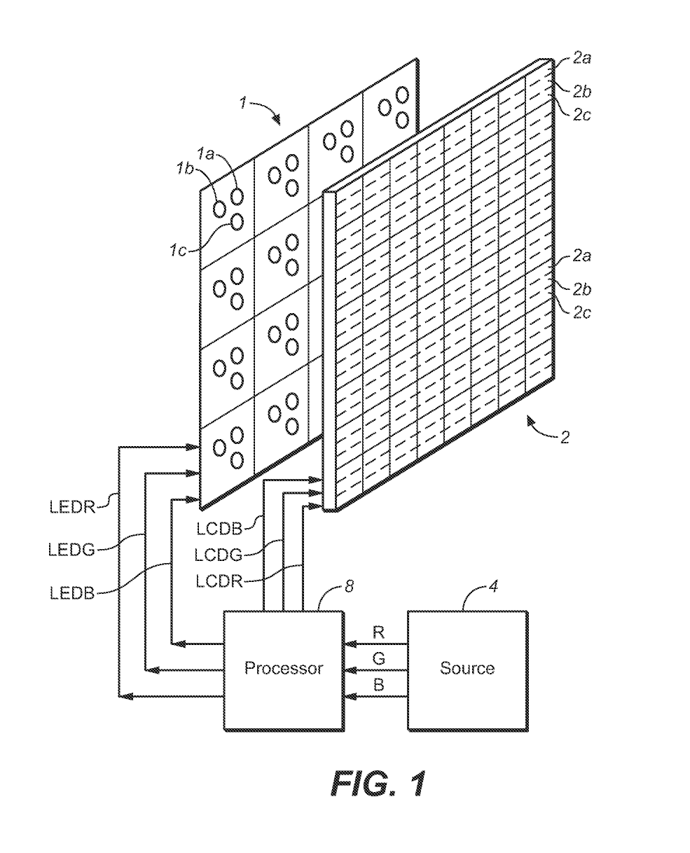

Many embodiments of the present invention are technologically possible. It will be apparent to those of ordinary skill in the art from the present disclosure how to implement them. Embodiments of the inventive system and method will be described with reference to FIGS. 1 and 9-12.

FIG. 1 is a block diagram of an embodiment of the inventive system. The system of FIG. 1 includes a dual modulation display for displaying images sequentially in response to a video input signal from source 4. The display comprises front modulating panel 2 and backlight panel 1 positioned (by means not shown) behind panel 2. Optionally, a diffuser panel (not shown) is positioned between panels 1 and 2. The system also includes processor 8, coupled between the dual modulation display and source 4 and configured to generate driving signals for both panels of the display in response to the input signal.

In FIG. 1, processor 8 has outputs coupled to backlight panel 1 and to panel 2, and inputs coupled to source 4. Another embodiment of the invention is processor 8 alone, with outputs configured to be coupled to panels 1 and 2. In both the latter embodiment and the FIG. 1 system, processor 8 is optionally configured to store or generate a video input signal (or other input image data) that is processed in accordance with the inventive method to generate backlight drive values.

In a typical implementation of FIG. 1, front modulating panel 2 is an LCD panel comprising an array of pixels. Each pixel includes three LCD cells (subpixels): a red cell 2a (which has variable transmittance to red light and is opaque to light other than red light); a green cell 2b (which has variable transmittance to green light and is opaque to light other than green light); and a blue cell 2c (which has variable transmittance to blue light and is opaque to light other than blue light).

In a typical implementation, backlight panel 1 of FIG. 1 is an LED panel comprising an array of LED cells, each cell including three LEDs: a red LED 1a; a green LED 1b; and a blue LED 1c. LED panel 1's cells have lower (and typically much lower) density than panel 2's pixels so that each LED cell of panel 1 backlights many pixels of panel 2 and panel 1 has lower resolution than panel 2. As shown in FIG. 1, there is one LED cell of panel 1 for each set of four LCD pixels of panel 2. The density and placement of the LED cells discourages individual modulation of the backlight for each individual LCD pixel. Instead, a distribution of light from each LED cell (1a, 1b, and 1c) backlights many LCD pixels. The light emitted from each LED cell typically overlaps that emitted from other ones of the LED cells, resulting in a backlight that changes slowly (spatially) relative to the LCD pixels. Thus, multiple LCD pixels in each area of panel 2 have a similar backlight.

To display an image in response to a frame (or field) of the input signal, processor 8 asserts three sequences of LCD driving values (“LCDR,” “LCDG,” and “LCDB”) to panel 2 and three sequences of LED driving values (“LEDR,” “LEDG,” and “LEDB”) to panel 1. Each value “LCDR” determines the transmittance of a different one of cells 2a, each value “LCDG” determines the transmittance of a different one of cells 2b, each value “LCDB” determines the transmittance of a different one of cells 2c, each value “LEDR” determines the emitted intensity of a different one of red LEDs 1a, each value “LEDG” determines the emitted intensity of a different one of green LEDs 1b, and each value “LEDB” determines the emitted intensity of a different one of blue LEDs 1c.

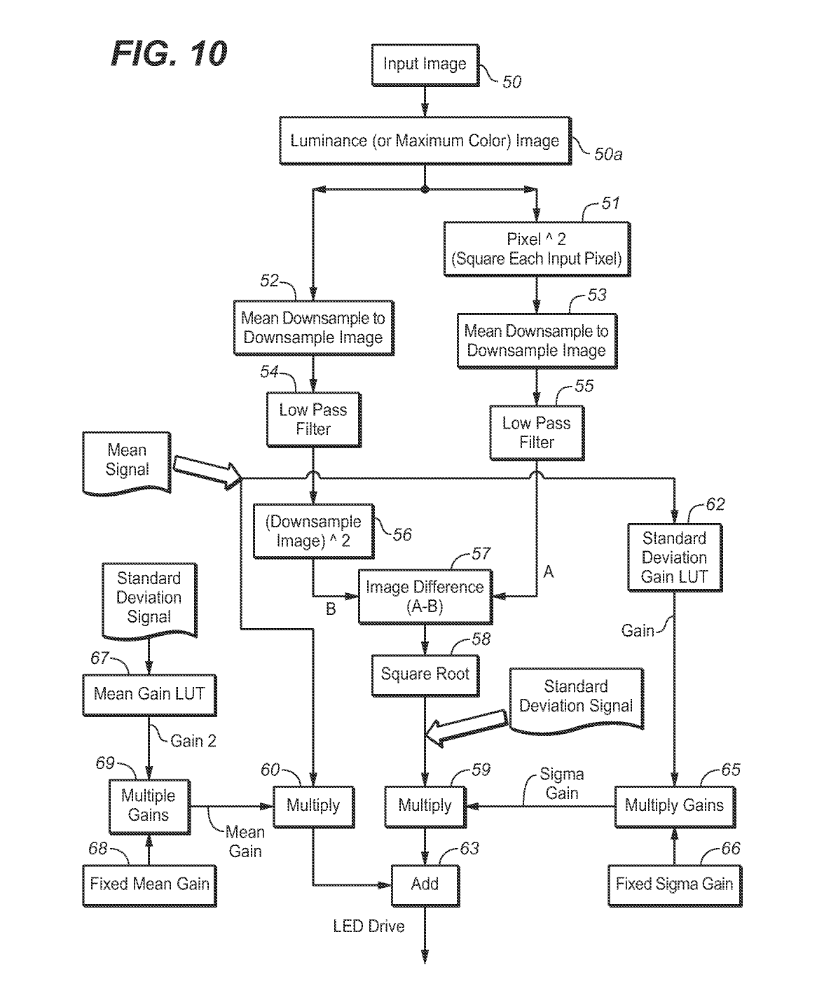

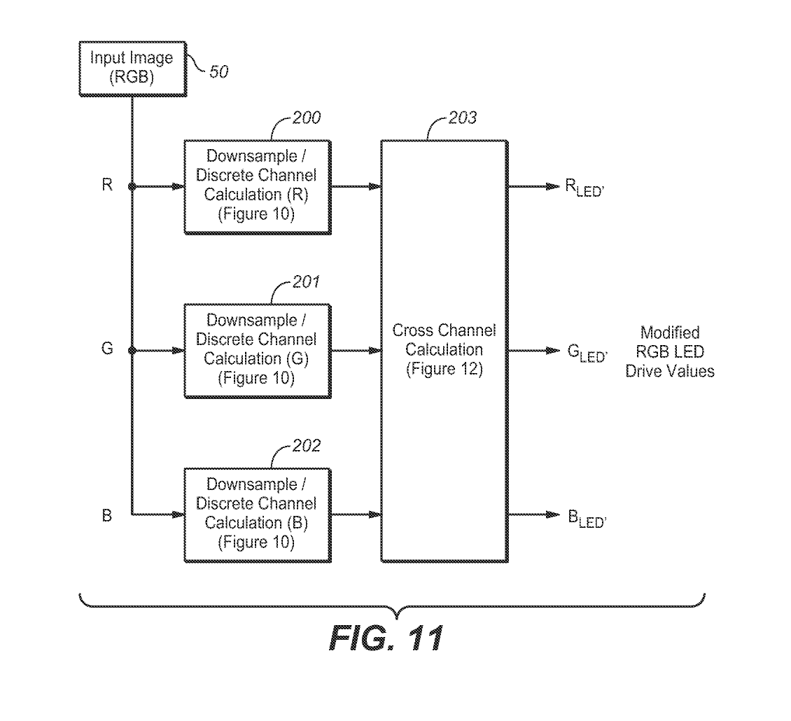

FIG. 9 is a flow diagram of steps performed in typical operation of the FIG. 1 system and other typical embodiments of the invention. In response to input image data 50, backlight drive values (e.g., LED drive values) are generated in step 70 of FIG. 9. For example, in operation of the FIG. 1 system, sequences “LEDR,” “LEDG,” and “LEDB” of backlight drive values may be generated (e.g., in a manner to be described with reference to FIG. 10 or FIG. 11) in response to a frame or field of image data 50 in step 70. Also in response to image data 50, LCD drive values are generated in steps 72 and 74. For example, in operation of the FIG. 1 system, step 72 of FIG. 9 generates sequences “LCDR,” “LCDG,” and “LCDB” of LCD panel control values in response to a frame or field of image data 50 and a set of simulated backlight pixels generated in step 74. The simulated backlight pixels are generated in step 74 (in a manner to be explained below) by simulating the backlighting achieved using the backlight drive values (LEDR, LEDG, and LEDB) generated in step 70.

In variations on the implementation shown in FIG. 1, a dual modulation display may include a backlight panel implemented with a single white light emitting element (e.g., a white light emitting diode) per cell rather than three LEDs (e.g., red, green, and blue LEDs) per cell, or with other multiple LED systems per cell (e.g., a red LED, a green LED, a blue LED, and a white LED for each cell). In other embodiments, the backlight layer of a dual modulation display may be implemented with a scanning laser, or as an LCD layer, a backlight projector, or other backlighting system or device, and/or the front (transmissive) layer may be implemented with other pixel elements (pixel elements other than LCDs) having variable transmittance. Typically but not necessarily, the backlight layer has a lower resolution than the front (transmissive) layer.

Dual modulation displays (e.g., the dual modulation display of FIG. 1) can provide greater contrast ratios than traditional displays if the LCD cells of their front panels (e.g., panel 2 of FIG. 1) and the light emitting elements of their backlight panels (e.g., backlight panel 1 of FIG. 1) are appropriately driven in response to the input images to be displayed. In operation, the backlight drive values (e.g., LED drive values) are preferably set to achieve an optimal backlight in a manner balancing the objectives of maximizing contrast, reducing or eliminating visual artifacts including white clipping, black clipping, halos, and temporal variations of these artifacts, and achieving energy efficiency.

Processor 8 of FIG. 1 is preferably configured to generate sequences “LEDR,” “LEDG,” and “LEDB” of LED drive values in a manner to be described in detail with reference to FIG. 10, in response to the red, green, and blue color components of each frame (or field) of a video input signal from source 4. This LED drive value determining operation is represented by step 70 of FIG. 9.

Preferably also, processor 8 of FIG. 1 is configured to generate sequences “LCDR,” “LCDG,” and “LCDB” of LCD drive values in a conventional manner in response to the red, green, and blue color components of each frame or field of a video input signal from source 4. This LCD drive value determining operation is represented by steps 72 and 74 of FIG. 9.

As noted, a dual modulation display system multiplies the effective contrast of its front (e.g., LCD) panel with the achieved contrast of its backlight subsystem to increase overall display contrast. In a conventional dual modulation display system with an LCD front panel and constant backlighting, the input image is typically sent directly to the LCD panel and displayed unaltered. However, in operation of the FIG. 1 system it is expected that the backlight modulation is sufficiently significant that driving the LCD panel directly with the input image would be insufficient and would result in a distorted output. Thus, steps 72 and 74 of FIG. 9 modify the input image data to account for the backlight contrast and to determine LCD drive values for displaying a correct viewable image.

To determine the LCD drive values to send to the LCD panel, step 74 implements a backlight model to simulate the backlight achieved with the LED drive values generated in step 70. Typically, backlight panel 1 comprises on the order of one thousand LED cells, and each of the LED cells is modeled as a white light emitting element in step 74. For example, the intensity of white light emitted from each cell that comprises a green LED, a blue LED, and a red LED is the sum (or other linear combination) of the green, blue and red intensities expected to be emitted from the three LEDs in response to the set of LED drive values LEDR, LEDG, and LEDB asserted to them.

In an exemplary implementation of step 74, the white backlight emitted from each LED cell (in response to the relevant set of drive values LEDR, LEDG, and LEDB) that is incident on each of the pixels of the LCD array is assumed to be that determined by a point spread function (e.g., a Gaussian point spread function, or a sum of weighted two-dimensional Gaussians, or an actually measured point spread function of an LED) centered at the LED cell's projection on the LCD array. For each pixel of the LCD array, the simulation assumes that the total intensity of backlight incident thereon is the sum of the incident intensities (at that pixel of the LCD array) of the backlight contributions emitted from each of the LED cells of the backlight array.

The output of step 74 is thus a set of incident backlight intensity values, one backlight intensity value for each pixel (LCD) of the LCD array, where each of the incident backlight intensity values is a sum of contributions from the individual LED cells of the backlight array.

In cases in which step 70 of FIG. 9 independently determines backlight drive values for each color channel of a backlight panel (e.g., in cases in which backlight drive values are generated as in the FIG. 11 embodiment, to be described below), step 74 would not implement a “white” backlight model as in the example described in the two preceding paragraphs, and would instead implement a model that appropriately models each color channel of the backlight panel.

In a typical case, each pixel of the LCD array includes an LCD that has variable transmittance to red light and is opaque to light other than red light, another LCD that has variable transmittance to green light and is opaque to light other than green light, and a third LCD that has variable transmittance to blue light and is opaque to light other than blue light.

In step 72, the simulated incident backlight intensity values (“backlight pixels”) determined in step 74 are used, with the input image data 50, to determine the LCD drive values (values LCDR, LCDG, and LCDB of FIG. 1) that are sent to the LCD panel. In a typical implementation of step 72, a ratio is determined for each color component of each pixel of the LCD array (i.e., for the “i”th LCD of the LCD array):

Ri=Pi/Bi, where

“i” is the index of the LCD array pixel, Bi is the simulated incident backlight intensity value for the LCD array pixel, and Pi is the intensity of the relevant color component of the relevant pixel of input image 50. Each ratio “Ri” (or a scaled version thereof) can be used as the LCD drive value for the LCD array pixel (e.g., the output of step 72 is a set of three LCD drive values, LCDR, LCDG, and LCDB, that satisfy LCDR=kᵣRiᵣ, LCDG=k_{g}Ri_{g}, and LCDB=k_{g}Ri_{b}, where kᵣ, k_{g}, and k_{g} are scaling factors (in some embodiments, the scaling factors are identical so that kᵣ=k_{g}=k_{g}=k), and Riᵣ, Ri_{g}, Ri_{b}, respectively, are the ratios Ri for the pixel's red, green, and blue color components). Thus, in this example, step 72 would pass through a pixel's color component Pi (of image 50) for use as an LCD drive value for the “i”th LCD (assuming the scaling factor k for the color component satisfies k=1) when the corresponding simulated incident backlight intensity value Bi is equal to 1 (indicating full or maximal backlighting of the LCD), but step 72 would effectively increase the LCD drive value for the LCD (thereby increasing the transmittance of the LCD) by the factor 1/Bi (again assuming k=1), when the simulated incident backlight intensity value Bi is less than one (Bi<1) indicating reduced (or than maximal) backlighting of the LCD.

Steps 72 and 74 can be performed in a manner that treats each color channel independently. For example, step 74 can independently determine three sets of simulated incident backlight intensity values, one set for each color component (green, blue, and red), each set comprising a backlight intensity value for one color component (green, blue, or red) of each pixel of the LCD array. In this example, step 72 can generate a green LCD drive value (LCDG) in response to (e.g., as a ratio of) the simulated green backlight intensity value for the LCD array pixel and the green color component of the corresponding pixel of input image 50, a blue LCD drive value (LCDB) in response to (e.g., as a ratio of) the simulated blue backlight intensity value for the pixel and the blue color component of the corresponding pixel of input image 50, and a red LCD drive value (LCDR) in response to (e.g., as a ratio of) the simulated red backlight intensity value for the pixel and the red color component of the corresponding pixel of input image 50.

In a preferred implementation of steps 72 and 74 that treats each color channel independently, the model implemented in step 74 assumes an XYZ color space rather than an RGB color space. One such model assumes the conventional CIE 1931 XYZ color space, a tristimulus color space model derived from direct measurements of the human eye and its three cone cell receptors (photoreceptors). The CIE 1931 XYZ colorspace is a well known and widely used standard space compatible with most instrumentation and is independent of the primaries in a system. Thus, the same CIE 1931 XYZ-based backlight model can be used for arbitrary backlight systems and primaries (e.g., for any LED backlight system comprising LED cells of any type). In a typical dual modulation display system, the LCD color filters (R,G,B) each let through a significant amount of “other” light that needs to be accounted for. A red LCD, for example, typically lets through a considerable amount of energy emitted by a green LED backlight, both in the red spectrum and in the green spectrum. A preferred XYZ color space implementation of step 72 thus includes twenty-seven light field simulations: each X, Y, and Z channel output from each RGB LED. Another preferred XYZ color space implementation of step 72 collapses the twenty-seven light fields into just nine backlights that are stored. The twenty-seven backlights in the simulations are each XYZ output from each RGB LED cell through each RGB LCD. However, since the Red, Green, and Blue LEDs in each RGB LED cell are essentially co-located and the drive values already determined, we can sum the XYZ outputs from each of the LEDs in the cell. In other words, the X output through the red LCD is the sum of the X output through the red LCD from the red, green, and blue LEDs; the Y output through the red LCD is the sum of the Y output through the red LCD from the red, green, and blue LEDs, and so on. For a given set of input pixel values (converted to XYZ space) and a 3×3 matrix of nine backlights, the R, G, and B LCD transmissivities are solved (preferably via a matrix inversion of the 3×3 matrix of backlights followed by a multiplication by the XYZ input).

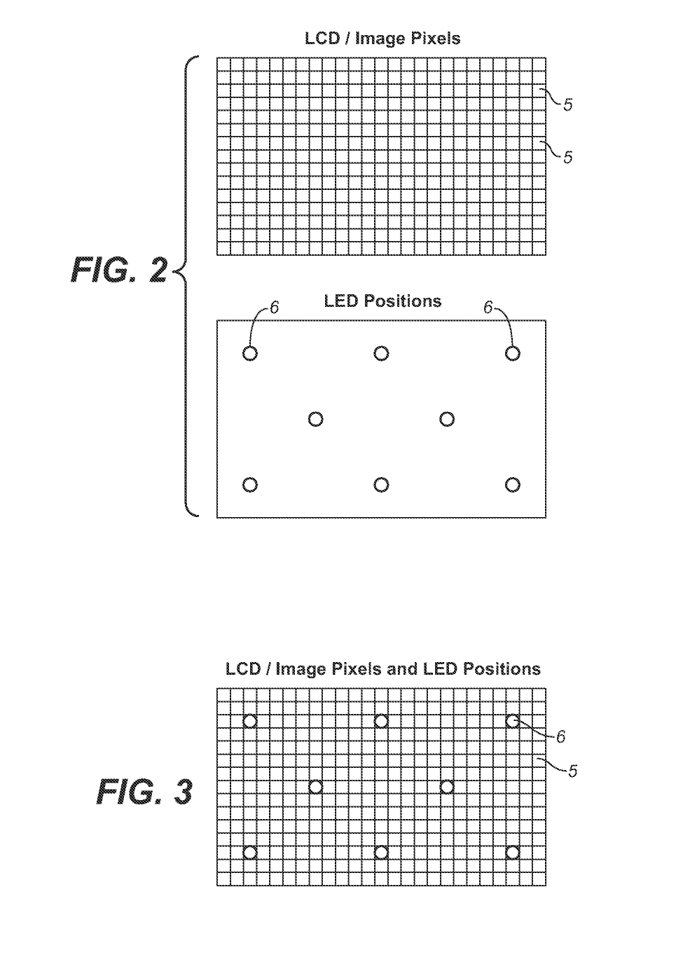

With reference to FIGS. 2-9, we next describe exemplary arrangements of front panel pixels and backlight cells of several dual modulation displays. Some embodiments of the invention assume the dual modulation display geometries of FIGS. 2-9.

In FIG. 2, pixels 5 are pixels of a high resolution LCD array (and pixels of an input image to be displayed by the LCD array) and LED cells 6 (of a backlight panel for the LCD array) are arranged hexagonally with lower resolution than pixels 5. FIG. 3 shows the high resolution LCD array aligned with (superimposed on) the lower resolution backlight panel. In operation, each LED cell 6 illuminates many pixels 5 of the LCD array.

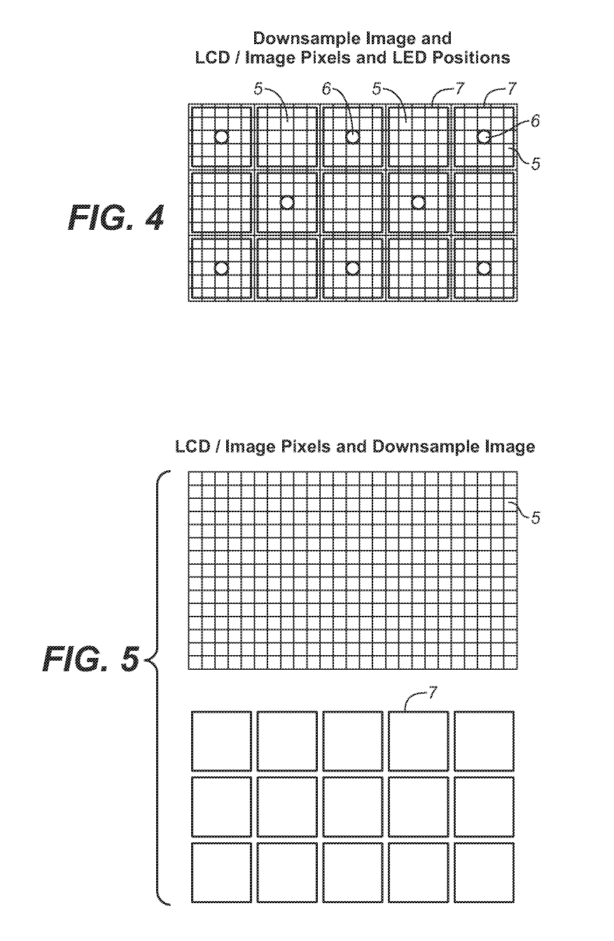

An example of a downsampled image that can be employed to generate backlight drive values for LED cells 6 (of FIGS. 2 and 3) will be described with reference to FIG. 4. Each “pixel” 7 of FIG. 4 is a data value of the downsampled image. Each such data value is a statistical measure (e.g., standard deviation or mean value) of a subset of twenty-five input image pixels 5. As apparent from FIG. 4, the location of each downsampled image “pixel” 7 corresponds to the location of a block of twenty-five input image pixels 5, and some but not all “pixels” 7 are superimposed on LED cells 6. In a class of embodiments of the inventive method, two downsampled images are generated from the input image comprising pixels 5: one downsampled image consisting of mean luminance values (the mean of the luminance values of each block of pixels 5 that is superimposed on an LED cell 6); the other downsampled image consisting of standard deviation values (the standard deviation of the luminance values of each block of pixels 5 that is superimposed on an LED cell 6). The mean and standard deviation values for each block of pixels 5 superimposed on an LED cell 6 can be used in accordance with the invention to determine backlight control values for the LED cell 6.

For clarity, FIG. 5 shows the high resolution input image pixels 5 of FIG. 4 separated from the lower resolution downsampled image “pixels” 7 of FIG. 4.

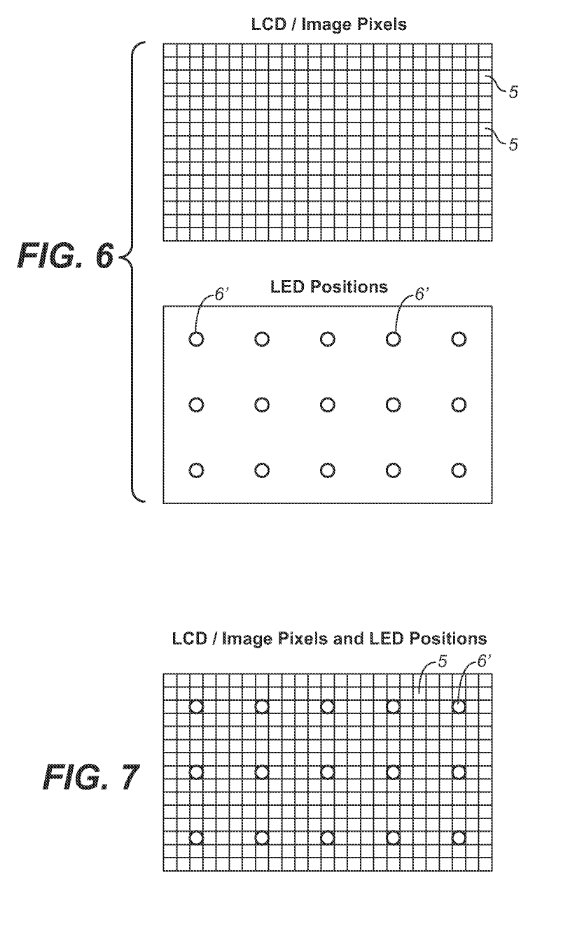

In another embodiment of the invention to be described with reference to FIGS. 6, 7, and 8, a dual modulation display has LED cells (cells 6′ of FIGS. 6-8) arranged in a rectangular grid. In FIG. 6, pixels 5 represent pixels of a high resolution LCD array (and pixels of an input image to be displayed by the LCD array) and LED cells 6′ of the display's backlight panel are arranged in a lower resolution rectangular grid. FIG. 7 shows the high resolution LCD array aligned with (superimposed on) the lower resolution backlight panel. In operation, each LED cell 6′ illuminates many pixels 5 of the LCD array.

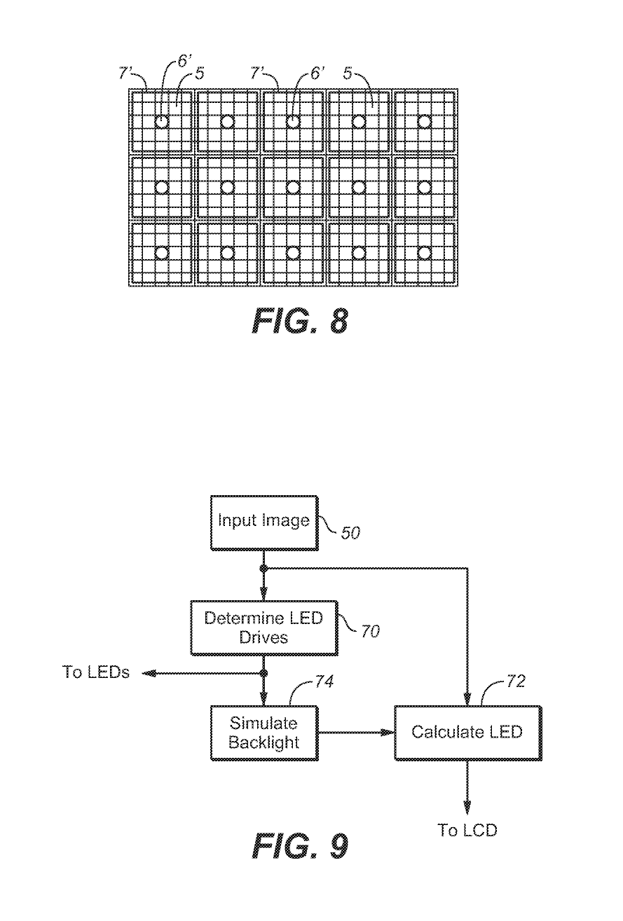

Another example of a downsampled image that can be employed to generate backlight drive values for LED cells 6′ (of FIGS. 6 and 7) will be described with reference to FIG. 8. Each “pixel” 7′ of FIG. 8 is a data value of the downsampled image. Each such data value is a statistical measure (e.g., standard deviation or mean value) of a subset of twenty-five input image pixels 5. As apparent from FIG. 8, the location of each downsampled image “pixel” 7′ corresponds to the location of a block of twenty-five input image pixels 5, and pixels 7′ are superimposed on LED cells 6′. In a class of embodiments of the inventive method, two downsampled images are generated from the input image comprising pixels 5: one downsampled image consisting of mean luminance values (the mean of the luminance values of each block of pixels 5 superimposed on an LED cell 6′); the other downsampled image consisting of standard deviation values (the standard deviation of the luminance values of each block of pixels 5 superimposed on an LED cell 6′). The mean and standard deviation values for each block of pixels 5 superimposed on an LED cell 6′ can be used in accordance with the invention to determine backlight control values for the LED cell 6′.

A straightforward backlight solution for a dual modulation display would be to set LED backlighting to center the dynamic range of the LCD panel at the average luminance of the input signal. Where each LED cell is aligned with an N×N block of pixels of the LCD panel, this could be achieved by generating a downsampled image whose data values are the average luminances of each N×N block of input image pixels to be displayed by the LCD panel pixels aligned with a different one of the LED cells, and setting each LED cell to twice the average input image luminance in the corresponding N×N block of input image pixels. In many cases, this would ensure that much of the image is reproducible using the LCD panel to set the final output level and would approximately balance the amount of white and black clipping for pixels outside that range. However this solution is lacking in several respects. For example, it would typically result in too much white clipping (the perception of white clipping is much more objectionable than the perception of black clipping to many viewers) and may also suffer from increased clipping in either the white or black regions if the input image signal luminance is not distributed equally about the average level. Average picture level (APL) is typically 15% for television images, so greater LED drive values (more than twice the average input image luminance in the relevant block) may be necessary for displaying television programs.

Preferred embodiments of the inventive method generate backlight drive values that set backlight level(s) to minimize white clipping and better follow the image signal pixel luminance distribution. This allows shifting of the local dynamic range towards the upper or lower end of the input signal. A desirable property of the backlight determined by such embodiments is that it observes image statistics to further ensure that clipping is minimized Statistical attributes (e.g., mean and standard deviation) of blocks of input image data are used to determine the backlight drive values in typical embodiments of the inventive method.

In a class of embodiments, backlight drive values are determined so as to set the backlighting on a local area basis according to statistical rules to ensure minimal clipping. For example, in accordance with some embodiments, the backlight for a local area of an image to be displayed is set to a level equal to a scaled mean of the luminance values (the mean multiplied by a scaling factor) of the pixels in a corresponding local area of the image, plus a scaled standard deviation of the luminance values (the standard deviation multiplied by a scaling factor) of the same image pixels. In one such embodiment, the backlight for a local area of an image to be displayed is set to the mean of the luminance values of the pixels in a corresponding local area of the image, plus three times the standard deviation of the luminance values of the same image pixels, resulting in 99% of the pixels not being clipped (if the luminance values of the image follow a normal distribution). For another example, in accordance with another such embodiment, the backlight for a local area of an image to be displayed is set to the mean of the luminance values of the pixels in a corresponding local area of the image, plus twice the standard deviation of the luminance values of the same image pixels. This results in 95% of the pixels not being clipped, again assuming that the luminance values of the image follow a normal distribution. For arbitrary probability distributions of luminance values of an input image, rather than normal distributions, Chebyshev's inequality states that no more than (1/k²) of the values are greater than “k” standard deviations from the mean. Thus, if the luminance values of the image follow an arbitrary distribution, 75% of the values are located within two standard deviations of the mean, and 89% of values are located with three standard deviations of the mean.

Standard deviation (sometimes referred to herein as ‘sigma’) and mean are statistical measures of subsets of pixels of an image (to be displayed) that are used to determine backlighting in accordance with some embodiments of the invention. In a class of embodiments, the backlight for each local area of the image is set at a level that is a function of these measures (e.g., a level determined by the sum of a scaled mean of luminance values of the image pixels in the local area and a scaled sigma of the luminance values of the same pixels). The particular function of statistical measures that is used is determined for the specific application by an application-specific tuned set of parameters (e.g., scaling factors). For example, if the backlight for each local area of an image is set at a level equal to the sum of a scaled mean of luminance values of image pixels in the local area and a scaled standard deviation of the luminance values of the same pixels, when determining backlighting for two different displays having LCD panels with different contrast ratios, a different set of scaling parameters may be chosen for each display.

Preferred embodiments of the invention use statistical attributes (e.g., mean and standard deviation) of blocks of input image data to determine backlight drive values and also employ an efficient method for determining the statistics of the input image data blocks. In accordance with the invention, statistical measures are determined from input image data at the relatively low resolution of a downsampled version of the input image.

As noted above, some embodiments of the inventive method generate two downsampled images from an input image to be displayed: one downsampled image consisting of mean luminance values (the mean of the luminance values of each block of pixels of the input image aligned with an LED cell of the backlight panel); and another downsampled image consisting of standard deviation values (the standard deviation of the luminance values of each block of pixels of the input image aligned with an LED cell of the backlight panel. LED drive values are determined from these downsampled images in a manner to be described below.

We next describe an example of such an embodiment with reference to the flow diagram of FIG. 10. As shown in FIG. 10, LED drive values are generated (in step 63) in response to input image data 50.

Where the input image data 50 are color image data comprising a sequence of pixels, each pixel consisting of a set of color components (e.g. red, green, and blue color components), a single value is generated in step 50a from the color components comprising each pixel of input image data 50. In typical implementations, step 50a generates a weighted sum of the color components of each input image pixel (e.g., the luminance of each pixel of each input image). In such implementations, the output of step 50a in response to each input image determined by data 50 is a “luminance image” consisting of a sequence of luminance values, where each luminance value is the luminance of a different pixel of input image.

Other implementations of step 50a determine the maximum color sample of each pixel of input image data 50. The maximum color sample of each pixel is the one of the pixel's color components (e.g., red, green and blue components) having the greatest value (greatest intensity). In these implementations, the output of step 50a is a stream of maximum color samples of the input image (i.e., the “i”th sample is the maximum of Ri, Gi, and Bi, where Ri, Gi, and Bi are the color components of the “i”th pixel of the input image).

In the following description of FIG. 10, each data value generated in step 50a will be referred (for simplicity) as a luminance value, although it could be another weighted sum of color components of each input image pixel or a maximum color sample of each input image pixel in some implementations.

In step 52, the luminance values generated in step 50a are “downsampled” in the sense that a downsampled image consisting of mean luminance values is generated from the data. More specifically, step 52 determines the mean of each of a number of blocks of the luminance values. Each block is a spatially compact set of the luminance values, whose spatial location in the input image corresponds to a subset of the LCD pixels (of the front panel) that is illuminated by one of the LED cells (of the backlight panel). The downsampled image generated in step 52 consists of values (sometimes referred to as “pixels”), each of which is the mean of a block of luminance values of pixels of the input image. The spatial location of each such “pixel” is the location of the block in the input image, and each mean luminance value is thus registered to the location of one such block.

In step 58 of FIG. 10, another downsampled image (consisting of standard deviation values) is also generated from the image data (to be referred to as luminance values) generated in step 50a. Steps 51, 53, 55, 56, and 57 are performed preliminary to performing step 58. In step 51, each image data value (luminance value) generated in step 50a is multiplied by itself. In step 53, the mean of the resulting squared luminance values in each of a set of local areas, or blocks, of the input image is determined, the mean of each of a number of blocks of the squared luminance values is determined. Each block is a spatially compact set of the squared luminance values, whose spatial location in the input image corresponds to a subset of the LCD pixels that is illuminated by one of the LED cells. The input image pixels are downsampled in step 53 in the sense that a downsampled image consisting of mean squared luminance values is generated from the data 50. The downsampled image generated in step 53 consists of values (sometimes referred to as “pixels”), each of which is the mean of a block of squared luminance values of pixels of the input image. The spatial location of each such “pixel” is the location of the block in the input image, and each mean squared luminance value is thus registered to the location of one such block.

When processing image data 50 for display on a dual modulation display having the LED cells 6′ and LCD pixels 5 of above-described FIGS. 6-8, each block of each input image for which a value is generated in step 52 (or step 53) of FIG. 10, is a 5×5 block of input image pixels. In other words, each pixel of each downsampled image determined in step 52 (or step 53) is registered to a 5×5 block of input image pixels.

In steps 54 and 55, the downsampled image generated in step 52 is low pass filtered (step 54) to limit its spatial bandwidth and the downsampled image generated in step 53 is low pass filtered (step 55) to limit its spatial bandwidth.

The sequence of filtered mean luminance values generated in step 54 in response to each input image is asserted to a look up table (LUT) to be described with reference to step 62, to a multiplication means to be described with reference to step 60, and to another multiplication means to be described with reference to step 56.

In step 56, each of the filtered mean luminance values generated in filtering step 54 is squared (multiplied by itself). In step 57, the squared filtered mean luminance values generated in step 56 (each of which is denoted in FIG. 10 as a value “B”) are subtracted from the filtered mean squared luminance values generated in filtering step 55 (each of which is denoted in FIG. 10 as a value “A”).

In step 58, the square root of each difference value output from step 57 is determined to generate a “standard deviation” value. The sequence of standard deviation values generated in step 58 in response to each input image is asserted to a look up table (LUT) to be described with reference to step 67, and to a multiplication means to be described with reference to step 59.

In a preferred implementation of FIG. 10, each standard deviation value generated in step 58 results from one pass data processing (without feedback) and is equal to:

$$σ = \sqrt{\frac{1}{N} ( {\sum }_{i = 1}^{N} {x}_{{i}^{2}} ) - {\overline{x}}^{2}} ,$$

where xᵢ is the low pass filtered luminance of the “i”th pixel of the input image, N is the number of luminance values in each block of the input image for which a value is generated in step 52 (or step 53) of FIG. 10, x̅ is the low pass filtered mean of the N luminance values in the same block of the input image, and σ (sigma) is the standard deviation of the N luminance values in the same block of the input image. As explained above, in some implementations of FIG. 10 each luminance value in the above expression for 6 is replaced by another weighted sum of color components of each input image pixel or by a maximum color sample of each input image pixel.

More generally, all steps of typical implementations of the FIG. 10 method are performed by one pass data processing (without feedback).

Still with reference to FIG. 10, in steps 59, 60, 65, 69, and finally step 63, the mean and standard deviation values generated in steps 54 and 58 are scaled based on fixed and variable gains and added together to determine the final backlight control values.

In step 62, a look up table (“standard deviation gain LUT”) outputs a gain value, “Gain,” in response to each mean value generated in step 54. In step 65, each “Gain” value is multiplied by a predetermined fixed gain value (“fixed sigma gain”) 66, to generate a scaling factor “SigmaGain.” The scaling factor “SigmaGain” value typically has a value equal to about 2.5. The standard deviation gain LUT contains values selected, or indexed, by the mean values. For each very low mean value (i.e., each mean value close to 0.0), the standard deviation gain LUT should output a Gain value of 1.0, which causes the “SigmaGain” value generated in step 65 to be equal to the “fixed sigma gain” 66. In response to a mean value (asserted to the input of the standard deviation gain LUT) equal to 0.5 or more, the standard deviation gain LUT should output a Gain value equal (or substantially equal) to zero (0.0), so that the “SigmaGain value (generated in step 65) is effectively zero and, with a typical “MeanGain” value equal to 2.0 generated in step 69, step 63 results in an LED drive value that causes the corresponding LED cell to emit backlight of maximum intensity (i.e., the LED drive value is a full on LED drive value). In other words, in response to a mean value (generated in step 54) equal to 0.5 or more, the output of step 63 is determined by the product of the mean value with the MeanGain value (generated in step 69) alone, and the sigma value (output from step 58) is not required to realize a sufficient backlight p 65 (SigmaGain) to 0.0. In response to a sequence of mean values (asserted to the input of the standard deviation gain LUT) increasing from about 0.0 to 0.25, the standard deviation gain LUT should output a sequence of Gain values that decrease rapidly from about 1.0 to a very small value (close to 0.0). In response to a sequence of mean values (asserted to the input of the standard deviation gain LUT) increasing from about 0.25 to 0.50, the standard deviation gain LUT should output a sequence of Gain values that decrease from this very small value to zero (0.0).

In step 67, a look up table (“mean gain LUT”) outputs a gain value, “Gain2,” in response to each standard deviation value generated in step 58. In step 69, each gain value, Gain2, is multiplied by a predetermined fixed gain value (“fixed mean gain”) 68, to generate a scaling factor “MeanGain.” The scaling factor “MeanGain” value typically has a value equal to about 2.0. The mean gain LUT contains values selected, or indexed, by the standard deviation values. Very low standard deviation values (e.g., values close to 0.0) indicate that the input signal is close to a flat field for an image area. In these cases, the “fixed mean gain” 68 which is typically about 2.0, is higher than required to provide a sufficient backlight. In flat image areas, setting the backlight closer to the mean is desirable from both energy savings and improved black clipping/contouring standpoints. Thus, the mean gain LUT contains fractional values less than 1.0 that, when multiplied by the “fixed mean gain” in step 69, will set the overall “MeanGain” to something typically close to 1.1 (e.g., the mean gain LUT typically contains values in the range from 1.1/2.0=0.55 to 1.0). In response to the input of the mean gain LUT of sequence of standard deviation values increasing from 0.0, the mean gain LUT should output a sequence of Gain2 values that increase from 0.55 to 1.0. A value of Gain2 equal to 1.0 allows the “MeanGain” value (output from step 69) to equal the fixed mean gain 68.

The gain values “fixed mean gain” 68 and “fixed sigma gain” 66 employed in steps 69 and 65 can be adjusted based on LCD and LED performance.

In step 60, each filtered mean luminance value (“mean”) generated in step 54 is multiplied by the MeanGain factor determined in response thereto (in step 69) to generate the product, “mean*MeanGain.”

In step 59, each standard deviation value (“sigma”) generated in step 58 is multiplied by the SigmaGain factor determined in response thereto (in step 65) to generate the product, “sigma*SigmaGain.”

In step 63, each product, “sigma*SigmaGain,” is added to the corresponding product, “mean*MeanGain,” to generate the backlight control value:

LED_{drive}=mean*MeanGain+sigma*SigmaGain.

Each value backlight control value LED_{drive} can be thought of as a “pixel” of a final downsampled image determined in step 63 in response to an input image. In a class of embodiments, each value LED_{drive} is an LED drive value for an LED (of a dual modulation display) which illuminates a block of the input image pixels.

Typically, the backlight panel responds to each backlight control value LED_{drive} that is equal to one (or greater than one) by fully driving the corresponding backlight, to cause it to emit backlight with maximum intensity. Alternatively, step 63 can be implemented to output either the value 1.0, or the value LED_{drive}, whichever is less, so that the backlight control values asserted to the backlight panel are always in the range from 0.0 to 1.0 (and backlight with maximum intensity is emitted only in response to a backlight control value equal to 1.0).

When the cells of the display's backlight panel are white LEDs, the backlight control values generated in step 63 (identified as “LED_{drive}” values in FIG. 10) can be directly applied to the white LEDs comprising the backlight panel cells. Or, when each cell of the backlight panel is a cluster of red, green and blue LEDs, each of the backlight control values generated in step 63 can be applied directly to all the LEDS of a different one of the clusters.

We next describe the type of low pass filtering applied in typical implementations of steps 54 and 55. As noted above, the relatively high resolution image pixels are downsampled (in the above-described sense) in accordance with the invention to the lower LED resolution. Since the input image typically has spatial frequencies much higher than can be represented at the LED array, the downsampling process must limit the frequencies in each downsampled image that is generated. Failure to do so will result in aliasing, which is caused by frequency ambiguity and can cause visual artifacts. In the case of aliased LED drive values, the resulting backlight may be higher or lower than desired, and may be unstable during movement (e.g., translation) of objects determined by a sequence of input images. For example, the backlight generated for a non-deforming objecting translating across the screen is ideally invariant to the object location. If bandlimiting is not performed, aliasing may manifest itself in a changing backlight, resulting in changing contouring, clipping, and halo artifacts.

To prevent aliasing that would otherwise result from the downsampling process, bandlimiting filtering is applied in steps 54 and 55. Preferably the bandlimiting (low pass) filter applied in step 54 removes high frequencies in each downsampled image generated in step 52, and the bandlimiting (low pass) filter applied in step 55 removes high frequencies in each downsampled image generated in step 53. The low pass filter characteristics, including frequency response and size, are preferably determined from the input image, the downconverted images, and the LED point spread function. Typically, each low pass filter applied in step 54 or 55 is significantly larger than the area of each block of image data values (i.e., the spatial area of each downsample pixel) whose mean is determined in step 52 or 53, in the sense that each value output from the low pass filter is a function of many pixels of each downsampled image that is asserted to the input of the low pass filter.

In accordance with the FIG. 10 embodiment, bandlimited mean and sigma downsampled images are combined to determine a final downsampled image consisting of LED drive values. For driving a rectangular LED array, every downsampled image location may contain (determine) an LED drive value, or a subset of the downsampled image locations (e.g., locations in every Nth row and Mth column of the downsampled image) may contain the LED drive values. For driving a hexagonal LED array (or one with another array geometry), LED drive values are contained at locations of the downsampled image that are aligned with actual LED locations.

The method of FIG. 10 is an embodiment of the inventive method for determining backlight drive values for backlight elements of a backlight panel of a dual modulation display (e.g., panel 1 of the FIG. 1 system) in response to input image data indicative of an image to be displayed. The method includes steps of:

(a) determining statistical data (the mean values generated in step 52 or 54 of FIG. 10 and the standard deviation values generated in step 58 of FIG. 10) indicative of at least two statistical measures of each of a number of spatially compact subsets of pixels of image data (blocks of the values generated in step 50a of FIG. 10), where the dual modulation display includes a front panel having a first resolution (e.g., panel 2 of the FIG. 1 system), the image data have the first resolution, the statistical data have resolution lower than said first resolution, and the pixels of image data are elements of the group consisting of pixels of the input image data, color components of pixels of the input image data, and data values derived from pixels of the input image data; and

(b) determining the backlight drive values (the output of step 63 of FIG. 10) from the statistical data.

As described above, a first class of embodiments of the invention determine a backlight control value for each cell (e.g., each LED cell) of the backlight panel of a dual modulation display in response to input image data. Typically, the input image data determine a sequence of color images, and comprise red, green, and blue color components (or other color components, in the case of images having non-RGB colorspaces). In typical embodiments in the first class, color components of each input image are transformed to determine a luminance image (e.g., a luminance value is determined for each pixel of the input image, by a traditional colorimetric technique such as a per-pixel weighted summation of the input image color components). Other typical embodiments in the first class determine the maximal value of the color components of each pixel of the input image (or each pixel of a subset of the pixels of the input image). The backlight control values are determined from the resulting luminance values or maximal color component values. The backlight control values (e.g., LED drive values) can be directly applied to white backlight cells of the backlight panel. For example, they can be applied directly to a white LED comprising each such cell, or directly to each LED of a cluster of red, green and blue LEDs comprising each such cell.

In a second class of embodiments of the inventive method and system, backlight control values are determined independently for each color channel of each cell of a backlight panel of a dual modulation display (e.g., for each of red, green, and blue channels of each cell of a backlight array). Typical embodiments in this class determine, for each color channel of the backlight array, at least one statistical attribute (e.g., mean or standard deviation) of each of a number of subsets (blocks) of color components (of pixels of an image to be displayed), and use the determined statistical attributes to generate, independently for each color channel of the backlight array, backlight control values for the color channel. Embodiments in the second class can improve both the achievable color gamut and overall system efficiency (relative to the color gamut and system efficiency achievable by the above-described first class of embodiments).

For simplicity in describing the second class of embodiments, we will refer to the color channels as “red,” “green,” and “blue” color channels (of an RGB color space). It should be understood that in some embodiments in the second class, the color channels are color components of another color space (e.g., cyan/magenta/yellow, or another non-RGB color space, which may be a tri- or multi-primary system).

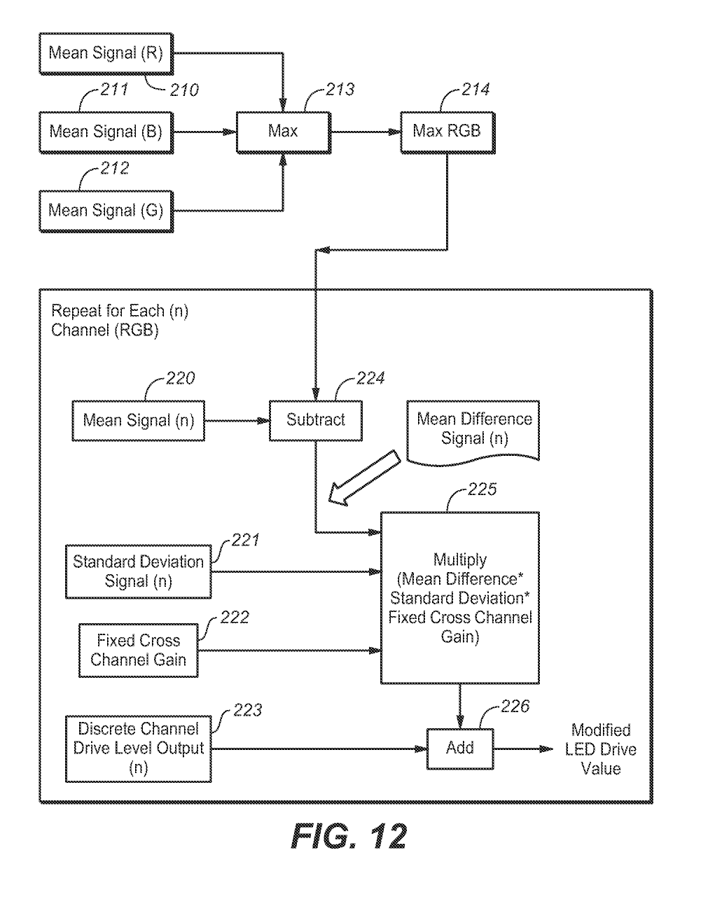

An embodiment in the second class will be described with reference to FIGS. 11 and 12. In the FIG. 11 system, each of blocks 200-203 can be implemented by image data processing circuitry (e.g., a subsystem of a field-programmable gate array or other integrated circuit or chip set). FIG. 12 is a flow diagram of steps performed in operation of a typical implementation of block 203 of FIG. 11.

In blocks 200, 201, and 202 of FIG. 11, the color component data in each color channel (e.g., red, green, and blue) of the input image are processed in a manner similar to that described with reference to FIG. 10. Specifically, where input image data 50 are streams of red, green, and blue color components, the red color components are processed in block 200 (of FIG. 11) in the same manner as luminance values that are output from step 50a of FIG. 10, to generate red LED control values “REDLED_{drive}” that would be identical to the “LED_{drive}” values generated in accordance with the FIG. 10 method if the red color component of each pixel of input image data 50 were output from step 50a of FIG. 10 (rather than the luminance or maximum color component value of such pixel). In other words, block 200 is configured to perform the same operations described in FIG. 10 on red color components of input image data 50 (rather than on the output of step 50a of FIG. 10). Similarly, the green color components of data 50 are processed in block 201 (of FIG. 11) in the same manner as luminance values that are output from step 50a of FIG. 10, to generate green LED control values “GREENLED_{drive}” that would be identical to the “LED_{drive}” drive generated in accordance with the FIG. 10 method if the green color component of each pixel of data 50 were output from step 50a of FIG. 10 (rather than the luminance or maximum color component value of such pixel), and the blue color components of data 50 are processed in block 202 (of FIG. 11) in the same manner as luminance values that are output from step 50a of FIG. 10, to generate blue LED control values “BLUELED_{drive}” that would be identical to the “LED_{drive}” values generated in accordance with the FIG. 10 method if the blue color component of each pixel of data 50 were output from step 50a of FIG. 10 (rather than the luminance or maximum color component value of such pixel).

The output of each of blocks 200, 201, and 202 is coupled to a different input of cross-channel block 203, as shown in FIG. 11. The individual color channel outputs (“REDLED_{drive}” from block 200, “GREENLED_{drive}” from block 201, and “BLUELED_{drive}” from block 202) are processed in cross-channel block 203 to determine the final LED drive values. Cross-channel block 203 analyzes the outputs of blocks 200, 201, and 202, and generates corrections for the outputs of blocks 200, 201, and 202 separately.

Simply applying the discrete color channel outputs from blocks 200-202 (REDLED_{drive} values from block 200, GREENLED_{drive} values from block 201, and BLUELED_{drive} values from block 202) directly to the LEDs is expected to generate useful results in some applications. However, it will often achieve insufficient results. Due to the overlapping nature of the point spread functions of the individual backlight elements of an LED backlight panel, as the size of a compact, single-colored (e.g., blue) area in an input image increases, the brightness of the area (using backlighting determined by applying the discrete color channel outputs from blocks 200-202 of FIG. 11 directly to red, green, and blue LEDs, respectively, of each cell of the backlighting array) also increases. Although the overlapping nature of the point spread functions of the individual backlight elements of an LED backlight panel does not cause undesirable image artifacts when driving an array of white LEDs using LED drive values determined in accordance with the FIG. 10 method (or, for each LED cell comprising red, green, and blue LEDs in an LED cell array, when applying the same LED drive value, determined in accordance with the FIG. 10 method, to all color channels of the LED cell), it can cause problems when independently driving each color channel of each cell of a multi-primary backlighting array (e.g., by applying the discrete color channel outputs from blocks 200-202 of FIG. 11 directly to red, green, and blue LEDs, respectively, of each cell of the LED cell array).

For example, when displaying a large white area with a small red object (having the same luminance as the white area) contained within the large area's boundaries (and applying the discrete color channel outputs from blocks 200-202 of FIG. 11 directly to red, green, and blue LEDs, respectively, of each cell of the backlighting array), the brightness level of the white object would be significantly higher than that of the red object due to the overlap effect of the significantly greater numbers of red, green and blue LEDs under (behind) the white area than red LEDs under (behind) the red object. Therefore, to ensure an adequate level of red backlight under the red object, the drive levels for the red channel must be boosted beyond those predicted by the downsample algorithm of FIG. 10. Block 203 of the FIG. 11 system functions to provide such boosting.

Operation of a typical implementation of block 203 of FIG. 11 will next be described with reference to FIG. 12. In FIG. 12, “mean” red signal 210 is the sequence of mean values generated in block 200 by performing the equivalent of steps 52 and 54 (of FIG. 10) on the sequence of red color components of the input image Similarly, “mean” blue signal 211 is the sequence of mean values generated in block 202 by performing the equivalent of steps 52 and 54 (of FIG. 10) on the sequence of blue color components of the input image, and “mean” green signal 212 is the sequence of mean values generated in block 201 by performing the equivalent of steps 52 and 54 (of FIG. 10) on the sequence of green color components of the input image.

The sequence of steps 224, 225, and 226 of FIG. 12 is performed three times (sequentially or simultaneously), once for each color channel. Steps 224-226 for the red color channel are performed in response to “mean” red signal 220 (the sequence of mean values generated in block 200 by performing the equivalent of steps 52 and 54 of FIG. 10 on the sequence of red color components of the input image), “standard deviation” red signal 221 (the sequence of sigma values generated in block 200 by performing the equivalent of steps 51, 53, 55, 56, 57, and 58 of FIG. 10 on the sequence of red color components of the input image), a predetermined fixed cross channel gain value 222, and the discrete color channel output 223 from block 200 (i.e., the sequence of drive values REDLED_{drive} output from block 200).

Steps 224-226 for the green color channel are performed in response to “mean” green signal 220 (the sequence of mean values generated in block 201 by performing the equivalent of steps 52 and 54 of FIG. 10 on the sequence of green color components of the input image), “standard deviation” green signal 221 (the sequence of sigma values generated in block 201 by performing the equivalent of steps 51, 53, 55, 56, 57, and 58 of FIG. 10 on the sequence of green color components of the input image), the fixed cross channel gain value 222, and the discrete color channel output 223 from block 201 (i.e., the sequence of drive values GREENLED_{drive} output from block 201).

Steps 224-226 for the blue color channel are performed in response to “mean” blue signal 220 (the sequence of mean values generated in block 202 by performing the equivalent of steps 52 and 54 of FIG. 10 on the sequence of blue color components of the input image), “standard deviation” blue signal 221 (the sequence of sigma values generated in block 202 by performing the equivalent of steps 51, 53, 55, 56, 57, and 58 of FIG. 10 on the sequence of blue color components of the input image), the fixed cross channel gain value 222, and the discrete color channel output 223 from block 202 (i.e., the sequence of drive values BLUELED_{drive} output from block 202).

In accordance with the FIG. 12 method, the “mean” signal from each of blocks 200, 201, and 202 is compared (in step 213) to determine the maximum mean value 214. Thus, in step 213, the “mean” red signal 210, the “mean” green signal 211, and the “mean” blue signal 212 for the same block of pixels of the input image are compared, and the result of the comparison is the maximum mean value 214 for that block of pixels of the input image.

Thus, step 213 determines a sequence of maximum mean values 214, including a maximum mean value for each spatially compact subset of a sequence of spatially compact subsets of pixels of the input image data, where the maximal mean value for each spatially compact subset of pixels of the input image data is a maximal one of the mean value 210 of the red color components of said spatially compact subset of pixels of the input image data, the mean value 211 of the blue color components of said spatially compact subset of pixels of the input image data, and the mean value 212 of the green color components of said spatially compact subset of pixels of the input image data

In step 224 for the red channel, the difference between the maximum mean value 214 (for each block of pixels of the input image) and the mean red signal 220 (for the same block of pixels of the input image) is calculated. Similarly, in step 224 for the green channel, the difference between the maximum mean value 214 (for each block of pixels of the input image) and the mean green signal 220 (for the same block of pixels of the input image) is calculated, and in step 224 for the blue channel, the difference between the maximum mean value 214 (for each block of pixels of the input image) and the mean blue signal 220 (for the same block of pixels of the input image) is calculated.

In step 225 for the red channel, the difference value generated in step 224 (for each block of pixels of the input image) is multiplied by the standard deviation red value 220 (for the same block of pixels of the input image) and the fixed cross channel gain value 222. The result of this multiplication is added (in step 226 for the red channel) to the red channel drive value 223 (“REDLED_{drive}”) generated in block 200 for the same block of pixels of the input image, to generate a modified red channel LED drive value, RLED′, for the same block of pixels of the input image (and thus for the red LED of the backlight array whose spatial location corresponds to that of the block of pixels of the input image).

In step 225 for the green channel, the difference value generated in step 224 (for each block of pixels of the input image) is multiplied by the standard deviation green value 220 (for the same block of pixels of the input image) and the fixed cross channel gain value 222. The result of this multiplication is added (in step 226 for the green channel) to the green channel drive value 223 (“GREENLED_{drive}”) generated in block 201 for the same block of pixels of the input image, to generate a modified green channel LED drive value, GLED′, for the same block of pixels of the input image (and thus for the green LED of the backlight array whose spatial location corresponds to that of the block of pixels of the input image).

In step 225 for the blue channel, the difference value generated in step 224 (for each block of pixels of the input image) is multiplied by the standard deviation blue value 220 (for the same block of pixels of the input image) and the fixed cross channel gain value 222. The result of this multiplication is added (in step 226 for the blue channel) to the blue channel drive value 223 (“BLUELED_{drive}”) generated in block 202 for the same block of pixels of the input image, to generate a modified blue channel LED drive value, BLED′, for the same block of pixels of the input image (and thus for the blue LED of the backlight array whose spatial location corresponds to that of the block of pixels of the input image).

The steps of FIG. 12 are performed for each block of pixels of the input image (whose spatial location corresponds to that of a different one of the LED cells of the backlight array) to generate a sequence of modified RGB LED drive value sets, RLED′, GLED′, and BLED′, one set for each LED cell of the backlight array.

By multiplying the mean difference signal (the output of step 224) by the standard deviation signal 221 and gain value 222, step 225 generates a sequence of product terms. Each product term in this sequence becomes significant only in a very limited set of circumstances. To have a small mean value and large standard deviation value, an area of the image may likely contain a small isolated bright feature in a particular color channel; for the mean difference value to be large, another, significantly larger area of the image must have another color with high brightness. In these cases, the product term created by the cross channel calculation (the output of step 225) is added (in step 226) to the raw LED drive value 223 to ensure that each modified LED drive value (the output of step 226) for the small bright area is sufficient to achieve a saturated color in that area.

Consider again the above-mentioned example in which a large white area is to be displayed with a small red object (having the same luminance as the white area) contained within the large area's boundaries. When generating backlight drive values for such an image, if the cross channel calculation implemented by block 203 were omitted, the small red area displayed in the large white area would suffer from significant desaturation from the surrounding white backlight. The resultant viewable image would either be a desaturated red color (tending towards white) if no hue preserving LCD clipping algorithm were implemented, or a significantly darkened red approaching gray or black if a hue preserving LCD clipping algorithm were implemented. These artifacts are reduced or eliminated by generating modified backlight drive values using the FIG. 11 system including block 203 thereof.

In this context, a hue preserving LCD clipping algorithm is a specific implementation of steps 72 and 74 (of above-described FIG. 9) performed to determine LCD drive values (“LCDR,” “LCDG,” and “LCDB) once a set of modified LED drive values has been determined (in step 70 of FIG. 9) using the FIG. 11 system (including block 203 or without block 203).

After the LED drive values have been determined (in step 70), a simulation of the backlight that will be achieved on the display using these drive values is performed (in step 74). From this simulation and the input image, the LCD drive values are determined (in step 72). Typically, step 72 includes simple division of input image pixels by simulated incident backlight intensity values (as described above).

If a pixel in the input image has an intensity of 50 units and the determined backlight at that pixel is 100 units, the LCD transmittance at the pixel (resulting from the output of step 72) would be 50/100, or 50%. This is readily achievable by an LCD panel. However, in some cases the determined backlight will be less than the input image intensity. For example, if a pixel of the input image has an intensity of 50 units but the determined backlight at the pixel is only 25 nits, the LCD transmittance required would be 200%. Of course an LCD can only pass light, so 100% is the maximum transmittance possible.

An LCD transmittance solution (determined by step 72) that is greater than 100% indicates a condition where the backlight is too low to achieve the desired brightness. This situation is termed as “LCD clipping” and results in displayed brightness lower than indicated by the input pixel.

For RGB (or other) color images, an additional complication arises when the backlight is too low resulting in LCD clipping. For each pixel of the input image, the ratios of red, green, and blue determine the color of the image. If these ratios are altered, the color is altered. If one (or more) LCDs clip, there is the possibility of the RGB ratios changing.

LCD transmittance solutions can be independently determined by step 72 for each of red, green, and blue LCDs based on the modeled backlight and input image. If clipping occurs in one or more color channels but is ignored, the color actually displayed will be different from the input image color. In the example given above, the red LCD would likely clip, and the resulting color would appear as a mix between red and white.

A solution (known as a hue preserving LCD clipping algorithm) is to maintain the RGB ratio even in the presence of clipping. To implement such a solution, step 72 (of FIG. 9) would include a step of using the greatest determined LCD transmittance (maximum transmittance) for one of the color channels to scale the LCD transmittance values for all color channels equally. For example, if the LCD transmittance solutions for red, green, and blue, respectively, were 200%, 90%, and 140%, the maximum transmittance of 200% would be used to determine the scaling factor. As 100% is the maximum achievable transmittance for an LCD, the 200% value would need to be scaled by one half to the achievable transmittance of 100%. This factor (one half) would then be applied to the other two color channels, resulting an implementation of step 72 that determines LCD drive values that in turn determine a final LCD transmittance set of 100% 45% and 70%, for the red, green, and blue channels, respectively. Although determination of LCD drive values in this way results in decreased displayed brightness, it preserves the displayed hue.

The described method performed by the FIG. 11 system (with block 203 of FIG. 11 performing the method steps described with reference to FIG. 12) is an embodiment of the inventive method for determining backlight drive values for backlight elements of each color channel of a backlight panel of a dual modulation display in response in response to input image data indicative of an image to be displayed, where the backlight panel has a first color channel for emitting light of a first color (red, in the case of FIG. 11), a second color channel for emitting light of a second color (green, in the case of FIG. 11), and a third color channel for emitting light of a third color (blue, in the case of FIG. 11), and the dual modulation display also includes a front panel having a first resolution. The method includes steps of:

(a) determining first statistical data (the mean and standard deviation data generated by block 200 of FIG. 11) indicative of at least one statistical measure of each of a number of spatially compact subsets of first image pixels, where the first statistical data have resolution lower than said first resolution, and the first image pixels are elements of the group consisting of color components having the first color of the input image data, and data values derived from color components having the first color of the input image data, and determining backlight drive values for the first color channel (the values 223 that are output from block 200) from the first statistical data;

(b) determining second statistical data (the mean and standard deviation data generated by block 201 of FIG. 11) indicative of at least one statistical measure of each of a number of spatially compact subsets of second image pixels, where the second statistical data have resolution lower than said first resolution, and the second image pixels are elements of the group consisting of color components having the second color of the input image data, and data values derived from color components having the second color of the input image data, and determining backlight drive values for the second color channel (the values 223 that are output from block 201) from the second statistical data;

(c) determining third statistical data (the mean and standard deviation data generated by block 202 of FIG. 11) indicative of at least one statistical measure of each of a number of spatially compact subsets of third image pixels, where the third statistical data have resolution lower than said first resolution, and the third image pixels are elements of the group consisting of color components having the third color of the input image data, and data values derived from color components having the third color of the input image data, and determining backlight drive values for the third color channel (the values 223 that are output from block 202) from the third statistical data; and

(d) performing cross-channel correction (in block 203 of FIG. 11) on the backlight drive values for the first color channel, the backlight drive values for the second color channel, and the backlight drive values for the third color channel to generate modified backlight drive values for the first color channel (the output of step 226 of FIG. 12 for the red channel), modified backlight drive values for the second color channel (the output of step 226 of FIG. 12 for the green channel), and modified backlight drive values for the third color channel (the output of step 226 of FIG. 12 for the blue channel).

We next describe embodiments of the inventive method and system which generate LED drive values (for a dual modulation display) in the perceptual gamma-encoded (or gamma-corrected) domain.

Video signals may be represented in many ways. Linear video corresponds to a signal encoding that is directly related to physical processes, such as the number of photons. Perceptual domain encodings are often used in video to reduce the number of bits required to accurately characterize a signal. Perceptual encodings achieve efficiency by eliminating codes that are imperceptible with human vision. Log and gamma encodings are common encodings that are considered perceptual.

Various embodiments of the inventive method and system generate LED drive values (for a dual modulation display) in a variety of domains, including the perceptual gamma-encoded (or gamma-corrected) domain. There are two reasons for performing the LED drive value generation in the perceptual gamma-corrected domain. The first reason is that the bit-depth requirements are greatly reduced when the method or system operates in the perceptual domain. When the LED drive value generation is performed the perceptual gamma-corrected domain, the required filters and arithmetic processes would require significantly fewer bits (and less processing power) and the potential for errors in dark regions would be decreased. The second reason is that performance of LED drive value generation in the perceptual gamma-corrected domain can provide a desired “centering” of the LCD transmittance range around the perceptual signal to allow the LCD array to express high-resolution detail above and below its average level without clipping.

In some embodiments, the inventive system includes a dual modulation display including a front panel (e.g., panel 2 of FIG. 1) having a first resolution and a backlight panel (e.g., panel 1 of FIG. 1) having a second resolution, where the second resolution is less than the first resolution and the backlight panel is positioned to backlight the front panel; and a processor (e.g., processor 8 of FIG. 1) coupled to the dual modulation display and configured to downsample a set of image pixels (e.g., image data 50 of FIG. 10) to generate downsample image pixels (e.g., the output of step 52 or 53 of FIG. 10), to bandlimit the downsample image pixels to generate a first signal (e.g., the output of step 54 or 55 of FIG. 10), and to determine (and typically to generate) from the first signal (directly or indirectly), backlight drive values (e.g., LED drive values output from step 63 of FIG. 10) which determine backlight for the dual modulation display, preferably such that the backlight has the property of stability.

In other embodiments, the inventive system does not include a dual modulation display, but is or includes a processor (e.g., of the type described in the previous paragraph) configured to be coupled to a dual modulation display including a front panel (e.g., panel 2 of FIG. 1) having a first resolution and a backlight panel (e.g., panel 1 of FIG. 1) having a second resolution.

Preferably, backlight drive values generated by the processor (of the system of either of the two previous paragraphs) are capable of driving the backlight panel to cause it to emit stable backlight for display (by the front panel) of an image determined by the image pixels. In some implementations, the dual modulation display is configured to display an image with full resolution and the processor is configured to perform low-pass filtering on downsample image pixels (e.g., the output of step 52 of FIG. 10) having a second resolution less than the full resolution. Typically, the first signal is indicative of a statistical measure of each of a number of spatially compact subsets of the image pixels. The system may also be configured to pre-process the image pixels to generate processed image pixels (e.g., the output of step 51 of FIG. 10), to downsample and band limit the processed image pixels to generate a second signal (e.g., the output of step 55 of FIG. 10), to generate (in response to the first signal and the second signal) a third signal (e.g., the output of step 58 of FIG. 10) indicative of a second statistical measure of each of the spatially compact subsets of the image pixels, and to determine each of the backlight drive values by generating a linear combination of a value determined by the first signal and a value determined by the third signal. The pre-processing of the image pixels may consist of squaring each of the image pixels (e.g., a squaring operation as performed in step 51 of FIG. 10).

In some embodiments, the inventive system is or includes a field-programmable gate array (FPGA), or other integrated circuit or chip set, programmed and/or otherwise configured to perform an embodiment of the inventive method in response to input image data asserted thereto). In other embodiments, the inventive system is or includes another programmable digital signal processor (DSP) programmed and/or otherwise configured to perform pipelined processing, including an embodiment of the inventive method, on video data. Alternatively, the inventive system is or includes a programmable general purpose processor (e.g., a PC or other computer system or microprocessor) coupled to receive or to generate input data indicative of a sequence of images to be displayed, and programmed with software or firmware and/or otherwise configured (e.g., in response to control data) to perform any of a variety of operations on the input data, including an embodiment of the inventive method. For example, the inventive system may be or include a computer system (e.g., a PC) including an input device, a memory, and a graphics card that has been appropriately programmed (and/or otherwise configured) to perform an embodiment of the inventive method in response to input image data asserted thereto. The graphics card may include a graphics processing unit (GPU), or set of GPUs, dedicated for processing image data and configured to perform an embodiment of the inventive method. A general purpose processor configured to perform an embodiment of the inventive method would typically be coupled to an input device (e.g., a mouse and/or a keyboard), a memory, and a display device.

For example, processor 8 of the FIG. 1 system can be implemented as a general purpose processor (e.g., a PC or other computer including an input device and a memory) having inputs coupled to source 4 and outputs coupled to display 1, said processor (or a graphics card thereof) having been programmed with software and/or firmware to generate LCD and LED drive values for display 1 in response to image data from source 4 (or image data stored or generated within processor 8) in accordance with an embodiment of the inventive method. For another example, processor 8 of the FIG. 1 system is implemented as an appropriately configured FPGA or DSP (e.g., an FPGA or DSP, having inputs coupled to source 4 and outputs coupled to display 1, and comprising circuitry that has been configured with firmware and/or software to perform pipelined processing on video data from source 4 to generate LCD and LED drive values for display 1 in accordance with an embodiment of the inventive method).

For another example, the inventive system is implemented as a display device including a dual modulation display (e.g., a dual modulation display comprising front modulating panel 2 and backlight panel 1 as in FIG. 1) and a processor (e.g., processor 8 of FIG. 1) implemented an appropriately configured FPGA (or DSP) and coupled to the display. The processor is configured to receive input image data, to perform an embodiment of the inventive method in response to the input image data to generate (and assert to the display) backlight control values (e.g., LED drive values) for the display's backlight panel, and also to generate (and assert to the display) front panel control values (e.g., LCD drive values) for the display's front panel.

Another aspect of the invention is a computer readable medium (e.g., a disc) which stores code for implementing any embodiment of the inventive method.

While specific embodiments of the present invention and applications of the invention have been described herein, it will be apparent to those of ordinary skill in the art that many variations on the embodiments and applications described herein are possible without departing from the scope of the invention described and claimed herein. It should be understood that while certain forms of the invention have been shown and described, the invention is not to be limited to the specific embodiments described and shown or the specific methods described.

1-89. (canceled)

90. A method for determining backlight drive values for backlight elements of a backlight panel of a dual modulation display in response to input image data indicative of an image to be displayed, the method comprising the steps of:
(a) determining statistical data indicative of at least one statistical measure of each of a number of spatially compact subsets of pixels of image data, including by performing at least one nonlinear operation on each of the spatially compact subsets, where the dual modulation display comprises a front panel having a first resolution, the image data being mapped to the first resolution, the statistical data have resolution lower than the first resolution, and the pixels of image data comprise elements of the group consisting of pixels of the input image data, color components of pixels of the input image data, and data values derived from pixels of the input image data, and
band-limiting the statistical data; and
(b) determining the backlight drive values from the band-limited statistical data, wherein the statistical data are indicative of the mean and standard deviation of each of the spatially compact subsets, and step (a) comprises a step of determining standard deviation values including by filtering mean values of the spatially compact subsets to determine filtered mean values, and squaring each of the filtered mean values.

91. The method as recited in claim 90, wherein the pixels of image data comprise luminance values, including a luminance value for each pixel of the input image data.

92. The method as recited in claim 90, wherein the pixels of image data comprise maximal color components, including a maximal color component of the color components of each pixel of the input image data.

93. The method as recited in claim 90, wherein the statistical measure comprises the standard deviation of each of the spatially compact subsets of pixels of image data.

94. The method as recited in claim 90, wherein step (a) comprises a step of determining the mean and the standard deviation of each of the spatially compact subsets of pixels and step (b) comprises a step of determining each of the backlight drive values from a linear combination of the standard deviation and the mean of a different one of the spatially compact subsets of pixels.

95. The method as recited in claim 90, wherein the nonlinear operation is performed on data derived from each of the spatially compact subsets.

96. The method as recited in claim 90, wherein the nonlinear operation comprises an operation of squaring pixels of each of the spatially compact subsets.

97. The method as recited in claim 96, wherein the statistical measure comprises the standard deviation of each of the spatially compact subsets.

98. The method as recited in claim 90, wherein the nonlinear operation comprises an operation of squaring pixels of a downsampled image determined from the spatially compact subsets.

99. The method as recited in claim 98, wherein the nonlinear operation comprises an operation of squaring the mean value of each of the spatially compact subsets, where each pixel of the downsampled image comprises the mean value of a different one of the spatially compact subsets.

100. The method as recited in claim 98, wherein the nonlinear operation comprises an operation of squaring low-pass filtered mean values of the spatially compact subsets.

101. The method as recited in claim 90, wherein steps (a) and (b) are performed such that, in response to the backlight drive values determined in step (b), the backlight panel produces stable backlight.

102. The method as recited in claim 90, wherein steps (a) and (b) are performed by single pass data processing without feedback.

103. A processor for generating backlight drive values for backlight elements of a backlight panel of a dual modulation display in response to input image data indicative of an image to be displayed, wherein the dual modulation display also comprises a front panel having a first resolution and the processor is configured to:
determine and band-limit statistical data indicative of at least one statistical measure of each of a number of spatially compact subsets of pixels of image data, including by performing at least one nonlinear operation on each of the spatially compact subsets, wherein the image data are mapped to the first resolution, the statistical data have a resolution lower than the first resolution, and the pixels of image data comprise elements of the group consisting of pixels of the input image data, color components of pixels of the input image data, and data values derived from pixels of the input image data;
and generate the backlight drive values in response to the band-limited statistical data,
wherein the statistical data are indicative of the mean and standard deviation of each of the spatially compact subsets, and the processor is configured to generate standard deviation values including by filtering mean values of the spatially compact subsets to determine filtered mean values, and squaring each of the filtered mean values.

104. An apparatus, comprising:
a dual modulation display including a front panel having a first resolution and a backlight panel having a second resolution, where the second resolution is less than the first resolution and the backlight panel is positioned to backlight the front panel; and
a processor, coupled to the dual modulation display and configured to downsample a set of image pixels to generate downsample image pixels, to band-limit the downsample image pixels to generate a first signal, and to determine backlight drive values from the first signal such that backlight drive values are capable of driving the backlight panel to cause the backlight panel to emit stable backlight for display by the front panel of an image determined by the image pixels,
wherein the image pixels have the first resolution, the downsample image pixels have the second resolution, and the processor is configured to perform low-pass filtering on the downsample image pixels,
wherein the first signal is indicative of a statistical measure of each of a number of spatially compact subsets of the image pixels,
wherein the processor is configured to pre-process the image pixels to generate processed image pixels, to downsample and band limit the processed image pixels to generate a second signal, to generate, in response to the first signal and the second signal, a third signal indicative of a second statistical measure of each of the spatially compact subsets of the image pixels, and to determine each of the backlight drive values by generating a linear combination of a value determined by the first signal and a value determined by the third signal, and
wherein the processor is configured to pre-process the image pixels including by squaring each of the image pixels.

105. A system, comprising:
means for determining statistical data indicative of at least one statistical measure of each of a number of spatially compact subsets of pixels of image data, including by performing at least one nonlinear operation on each of the spatially compact subsets, where the dual modulation display comprises a front panel having a first resolution, the image data being mapped to the first resolution, the statistical data have resolution lower than the first resolution, and the pixels of image data comprise elements of the group consisting of pixels of the input image data, color components of pixels of the input image data, and data values derived from pixels of the input image data, and
means for band-limiting the statistical data; and
means for determining the backlight drive values from the band-limited statistical data, wherein the statistical data are indicative of the mean and standard deviation of each of the spatially compact subsets, and wherein the statistical data determination means comprises means for determining standard deviation values and wherein the standard deviation determination means comprises:
means for filtering mean values of the spatially compact subsets to determine filtered mean values; and
means for squaring each of the filtered mean values;
wherein the system functions to determine backlight drive values for backlight elements of a backlight panel of a dual modulation display in response to input image data, which is indicative of an image to be displayed therewith.
